(19) United States
(12) Patent Application Publication
(10) Pub. No.: US 2014/0151581 A1
(43) Pub. Date: Jun. 5, 2014

(54) TERAHERTZ SOURCE

(71) Applicants: Yael Nemirovsky, Haifa (IL); Dan Corcos, Haifa (IL); Gabriel Peled, Kibutz Moran (IL); Alexander Svetlitza, Haifa (IL); Sharon Bar-Lev-Shefi, Nofit (IL)

(72) Inventors: Yael Nemirovsky, Haifa (IL); Dan Corcos, Haifa (IL); Gabriel Peled, Kibutz Moran (IL); Alexander Svetlitza, Haifa (IL); Sharon Bar-Lev-Shefi, Nofit (IL)

(21) Appl. No.: 14/093,543

(22) Filed: Dec. 2, 2013

Related U.S. Application Data
(60) Provisional application No. 61/732,518, filed on Dec. 3, 2012.

(51) Int. Cl. G21K 5/00

(52) U.S. Cl. CPC G21K 5/00
USPC 250/504 R

(57) ABSTRACT

A TeraHertz radiating system that may include a blackbody arranged to emit blackbody radiation that comprises a TeraHertz component, a visible light component and an infrared component; and a filtering module that is arranged to pass the TeraHertz component and to reject the visible light component and the infrared component to provide filtered radiation.

### RELATED APPLICATION

This application claims the priority of U.S. provisional patent Ser. No. 61/732,518 filing date Dec. 3, 2012 which is incorporated herein by reference.

### BACKGROUND

TeraHertz radiation is defined as the range between 3*10¹¹ and 10¹³ Hertz. FIG. 1 illustrates a part of the electromagnetic spectrum and it includes TeraHertz radiation as well as microwave, infrared and visual light.

As active and passive real-time TeraHertz imaging and spectroscopy systems operating at TeraHertz frequencies continue to evolve, increasing attention is being directed towards the reduction of cost of TeraHertz sources to the calibration of filters and sensors at TeraHertz frequencies.

Commercial TeraHertz radiation sources are very expensive. A typical TeraHertz radiation source is a narrowband TeraHertz source, such as laser-based TeraHertz radiation source or spectrometers.

There is a growing need to provide cheap and reliable TeraHertz radiation sources and systems and methods that may utilize cheap and reliable TeraHertz radiation sources.

### SUMMARY

According to an embodiment of the invention there may be provided a TeraHertz radiating system that may include a blackbody arranged to emit blackbody radiation that may include a TeraHertz component, a visible light component and an infrared component; and a filtering module that may be arranged to pass the TeraHertz component and to reject the visible light component and the infrared component to provide filtered radiation.

The filtering module may include at least one mesh filter.

The filtering module may include scattering sheet filters.

The filtering module may include a cascade of mesh filters and scattering sheet filters.

The peak of radiation intensity of the blackbody radiation may be within a TeraHertz region.

The blackbody may be arranged to be heated to about 1200 Celsius when emitting the blackbody radiation.

The TeraHertz radiating system may include optics for directing the filtered radiation to a location of interest.

The TeraHertz radiating system may include a sensor adaptor arranged to (a) support a sensor, and to (b) receive detection signals generated from the sensor in response to the filtered radiation.

The TeraHertz radiating system may include a sensor.

The TeraHertz radiating system may include a modulator that may be arranged to prevent, during first periods of time, the sensor from receiving the filtered radiation and to pass, during second periods of time, the filtered radiation.

The processor may be arranged to process the detection signals received during the first and second periods of time.

The TeraHertz radiating system may include a processor for processing the detection signals and to provide information about sensing parameters of the sensor.

According to an embodiment of the invention there may be provided a method for generating and utilizing TeraHertz radiation, the method may include emitting, by a blackbody, blackbody radiation that may include a TeraHertz component, a visible light component and an infrared component; and filtering by a filtering module the blackbody radiation to provide filtered radiation thereby passing the TeraHertz component and rejecting the visible light component and the infrared component.

The filtering module may include at least one mesh filter.

The filtering module may include scattering sheet filters.

The filtering module may include a cascade of mesh filters and scattering sheet filters.

The peak of radiation intensity of the blackbody radiation is within a TeraHertz region.

The method may include heating the blackbody to about 1200 Celsius when emitting the blackbody radiation.

The method may include directing, by optics, the filtered radiation to a location of interest.

The method may include supporting, by a sensor adaptor, a sensor, and receiving detection signals generated from the sensor in response to the filtered radiation.

The method may include generating by a sensor detection signals in response to the filtered radiation.

The method may include processing, by a processor, the detection signals to provide information about sensing parameters of the sensor.

The method may include preventing by a modulator, during first periods of time, the sensor from receiving the filtered radiation and passing, during second periods of time, the filtered radiation.

The method may include processing, by a processor, detection signals received during the first and second periods of time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a prior art spectrum;

FIG. 2 illustrates various systems according to various embodiments of the invention;

FIG. 3 illustrates various systems according to various embodiments of the invention;

FIG. 4 illustrates a method according to an embodiment of the invention;

FIG. 5 illustrates the spectral radiant emittance normalized by the peak emittance, for several temperatures;

FIG. 6 illustrates normalized TeraHertz radiation, integrated over a given wavelength band corresponding to the designed sensor and total emitted radiation;

FIG. 7 illustrate TeraHertz radiation integrated over a given wavelength band corresponding to the designed sensor and a “leak” of several percent of infrared radiation on a linear scale;

FIG. 8 illustrates a calibration of the equivalent chopper temperature versus blackbody temperature;

FIG. 9 illustrates measured blackbody power using the calibrated commercial power meter, as a function of the blackbody temperature, without any filter;

FIG. 10 illustrates mesh filter transmission measured by an evacuated spectrometer;

FIG. 11 illustrates the mesh filters transmission (logarithmic scale) vs. wavelength, measured in a spectrometer, indicating the attenuation at IR and visible regions;

FIG. 12 illustrates a Spectral radiant emittance of a blackbody at T_{BB}=1000K, filtered with various filters and compared to the unfiltered emittance;

FIG. 13 illustrates a Spectral radiant emittance of a blackbody at various temperatures, filtered by a QMC K1713 (1.95 TeraHertz) filter;

FIG. 14 illustrates a comparison of expected and measured power by the Ophir sensor;

FIG. 15 illustrates the measured signal current of TMOS sensor with and without the Mesh filter;

FIG. 16 illustrates the expected power with various two filter combination at f/2 and in a 6.4 millimeter aperture;

FIG. 17 illustrates measured signal current and responsively vs. blackbody temperature and radiation power at chopper frequency of 1 Hz for a small array of sensors under study;

FIG. 18 illustrates a measured signal current vs. chopper frequency for several temperatures of the blackbody; and

FIG. 19 illustrates the noise PSD of the small array under study;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system

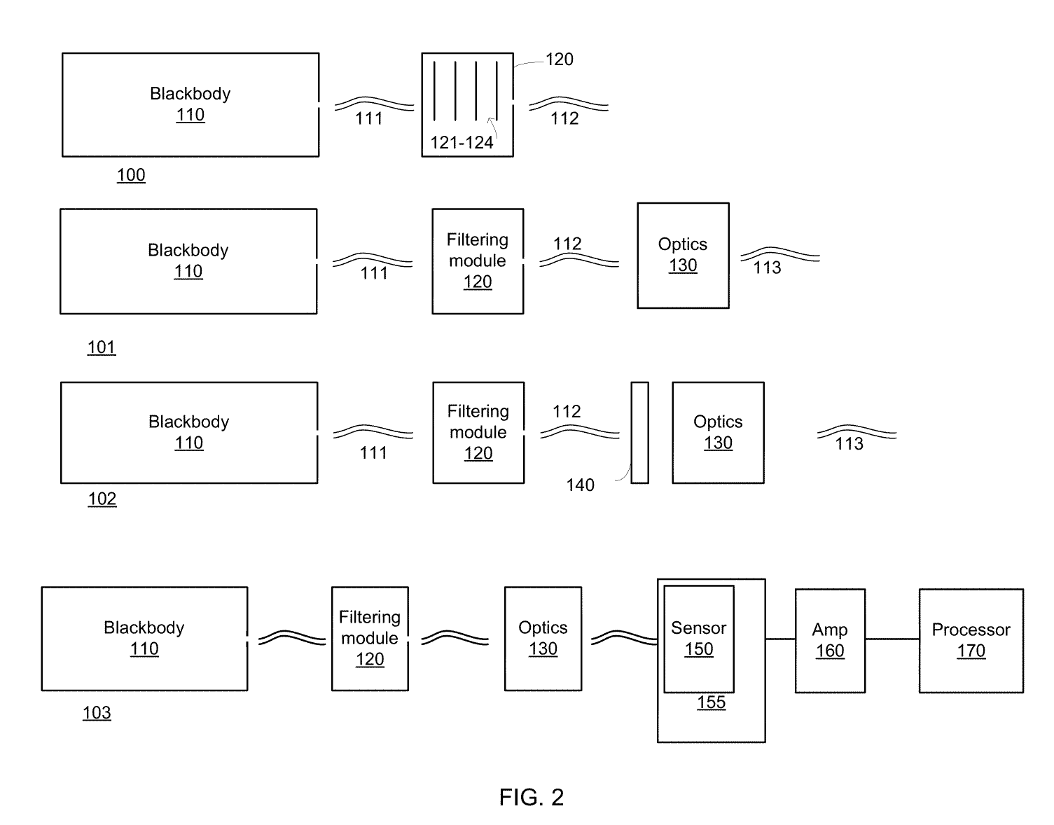

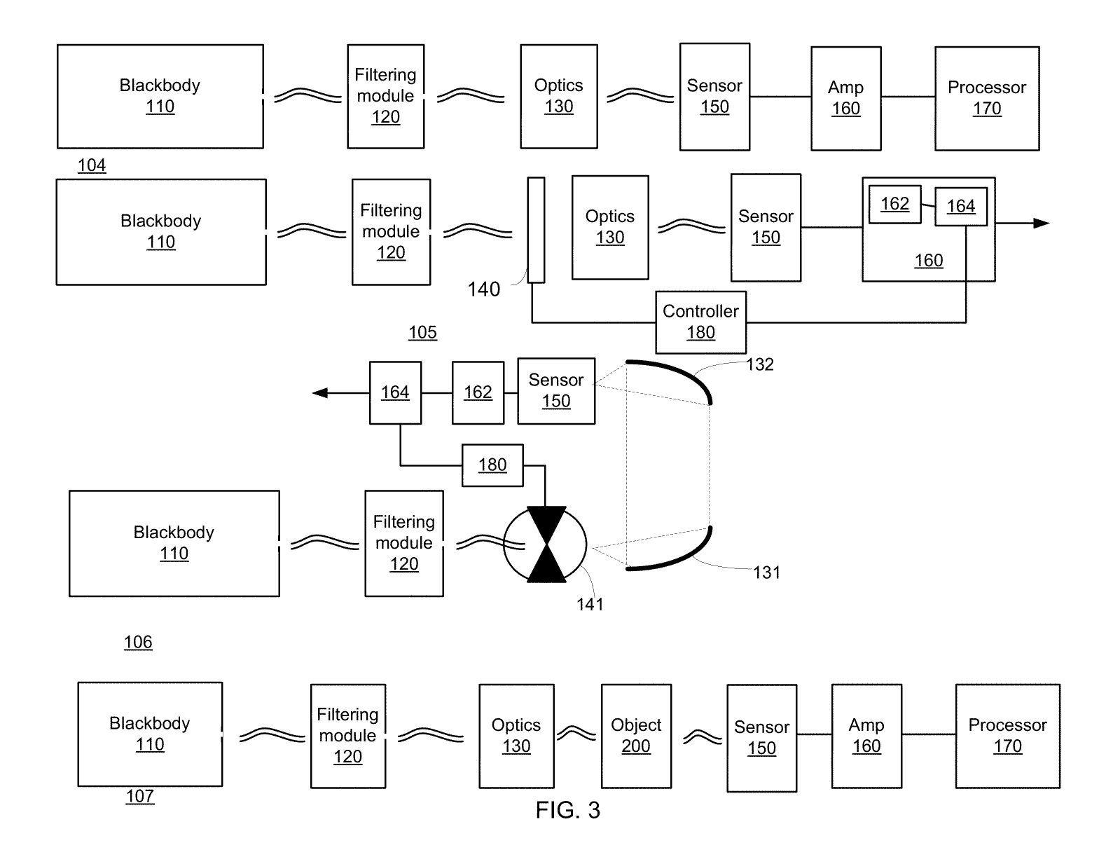

FIGS. 2-3 illustrates various systems 100-107 according to various embodiments of the invention.

System 100 is a TeraHertz radiating system and it includes (a) a blackbody 110 arranged to emit blackbody radiation 111 that includes a TeraHertz component (radiation in the TeraHertz range), a visible light component (radiation in the visible light range) and an infrared component (radiation in the infrared range); and (b) a filtering module 120 that is arranged to pass the TeraHertz component and to reject the visible light component and the infrared component to provide filtered radiation 112. The rejection may include completely suppressing the visible light and infrared components or at least suppressing these components below a desired threshold.

The blackbody can be any commercially available blackbody. It may is an off the shelf blackbody. The inventors used for their tests (Appendix A) a blackbody of Carmel Instruments Ltd. Blackbodies are highly stable and calibrated sources of radiation.

The filtering module 120 may include one or multiple filters (such as filters 121-124). There may be less than four filters or more than four filters. These filters may include at least one mesh filter, at least one scattering sheet filter or a combination thereof. The filtering module comprises a cascade of mesh filters and scattering sheet filters.

The blackbody may be heated to a temperature (for example about 1200 degrees Celsius) so that the peak of radiation intensity of the blackbody radiation is within a TeraHertz region. The term “about” means deviation of few percent (for example between plus five and minus five percent).

System 101 includes blackbody 110, filtering module 120 and optics 130 for directing the filtered radiation to a location of interest. The optics 130 output filtered radiation denoted as 113.

Optics 130 may include lenses, mirrors, filters, beam splitters, diffraction elements, polarizers and any element that may direct, manipulate or otherwise affect the propagation and/or optical characteristics of the radiation.

System 102 includes blackbody 110, filtering module 120, optics 130 and modulator 140. The modulator 140 module either one of the blackbody radiation 111, filtered radiation 112, radiation 113 outputted by optics or be positioned between different components of optics 130.

The modulation can include changing any of the characters of the modulated radiation. For example, it may change the amplitude, phase, polarization, or a combination thereof of the radiation.

According to an embodiment of the invention the modulator can block the radiation during first periods of time and allow passage of the radiation during second periods of time.

In system 102 the modulator 140 is illustrated as positioned between the filtering module 120 and the optics 130.

According to an embodiment of the invention a system may be provided for calibrating sensors. Thus, the sensor may be regarded as not being included in the system.

System 103 includes blackbody 110, filtering module 120, optics 130, sensor adaptor 155, amplification module 160 and processor 170.

The sensor adaptor 155 is arranged to (a) support a sensor 150, and to (b) receive detection signals generated from the sensor 150. The detection signals are amplified (or otherwise pro-processed) by amplification module 160 to provide amplified signals that are provided (usually after being converted to digital signals) to processor 170 for processing the amplified signals and determine the intensity or other parameters of the TeraHertz radiation. Processor 170 may also be arranged to determine sensing characteristics of the sensor 150 such as sensitivity, dynamic range, and the like. The latter may be determined based upon the expected values of the TeraHertz radiation. The expected values can be determined based upon the expected output level of the blackbody radiation and the expected filtering parameters of the filtering module1 120.

According to an embodiment of the invention the system can include the sensor and can be used for detection and/or analysis purposes.

System 104 includes blackbody 110, filtering module 120, optics 130, sensor 150, amplification module 160 and processor 170. For simplicity of explanation the sensor adaptor 155 is not shown. System 105 may include a modulator and a controller—but these elements are not illustrated. A controller can be included in any one of systems 100-104.

System 105 includes blackbody 110, filtering module 120, optics 130, modulator 140, sensor 150, amplification module 160, processor 170 and controller 180.

The amplification module 160 is illustrated as including amplifiers 162 and 164. Amplifier 162 may be a trans-impedance amplifier and amplifier 164 may be a lock-in amplifier 164 that is synchronized with the modulator 140. The modulator 140 may be a chopper or any other known modulating element.

The modulator 140 and amplifier 164 are controller by controller 180. The modulator 140 is arranged (under the control of controller 180) to prevent, during first periods of time, the sensor 150 from receiving the TeraHertz component and to pass, during second periods of time, the TeraHertz radiation.

The processor 170 is arranged to process the detection signals received during the first and second periods of time. The processor 170 may be arranged to compare between detection signals received during first periods (noise) and between detection signals received during second periods (signal plus noise). Appendix A provides various examples for such processing.

System 106 includes blackbody 110, filtering module 120, optics that include a pair of off-axis parabolic mirrors 131 and 132 that face each other, a chopper 141 that acts as a modulator, sensor 150, amplification module 160, processor 170 and controller 180.

System 107 includes blackbody 110, filtering module 120, optics 130, a modulator 140, sensor 150, amplification module 160 and processor 170. FIG. 3 also shows object 200 that is being examined by system 107. Filtered radiation may pass through the object 220 and be sensed by sensor 150. It is noted that optical components of optics 130 can be also positioned between object 200 and sensor 150, that system 107 may include one or more modulator, one or more controllers, and that it may exclude the amplifier. Object 200 can be inspected by any one of systems 106, 105, 104, 103. It is further noted that object 200 can be positioned such as to scatter radiation or reflect it—and its inspection may not be limited to transmissive detection.

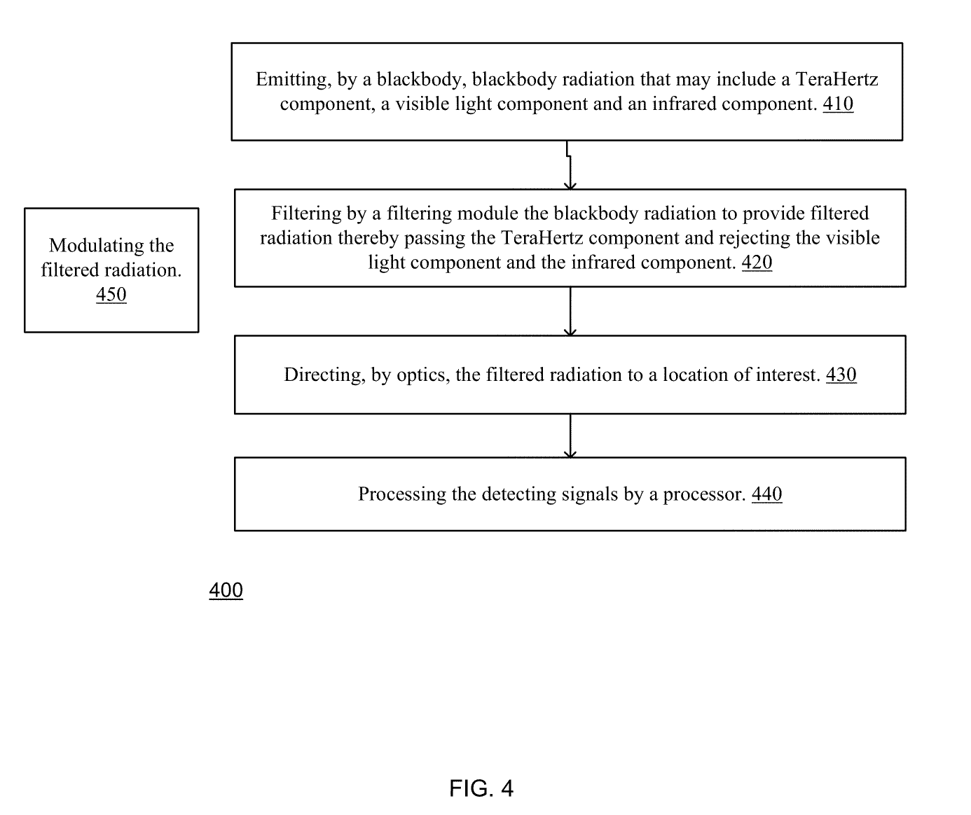

FIG. 4 illustrates method 400 according to an embodiment of the invention.

Method 400 or at least some stages of method 400 may be executed by systems such as systems 100-107.

Method 400 may start by stage 410 of emitting, by a blackbody, blackbody radiation that may include a TeraHertz component, a visible light component and an infrared component.

Stage 410 may include heating the blackbody to about 1200 Celsius when emitting the blackbody radiation.

Stage 410 may be followed by stage 420 of filtering by a filtering module the blackbody radiation to provide filtered radiation thereby passing the TeraHertz component and rejecting the visible light component and the infrared component. The filtering module may include at least one mesh filter. The filtering module may include scattering sheet filters. The filtering module may include a cascade of mesh filters and scattering sheet filters.

The peak of radiation intensity of the blackbody radiation is within a TeraHertz region.

Stage 420 may be followed by stage 430 of directing, by optics, the filtered radiation to a location of interest. The location of interest may be a desired location to which the filtered radiation should be directed. It may be a location of a sensor, a location of an object to be inspected or analyzed by using TeraHertz radiation, and the like.

Stage 430 may include sensing the filtered radiation by a sensor and generating detection signals reflecting the filtered radiation. The filtered radiation may be modulated, non-modulated, pass through an inspected object or not.

Stage 430 may be followed by stage 440 of processing the detecting signals by a processor.

FIG. 4 also illustrates stage 450 of modulating the filtered radiation. The modulating of stage 450 may be executed before stage 420, during the filtering of stage 420, after stage 420, before stage 430, during the directing of stage 430, after stage 430 or a combination thereof.

The modulating 450 may include preventing by a modulator, during first periods of time, the sensor from receiving the filtered radiation and passing, during second periods of time, the filtered radiation.

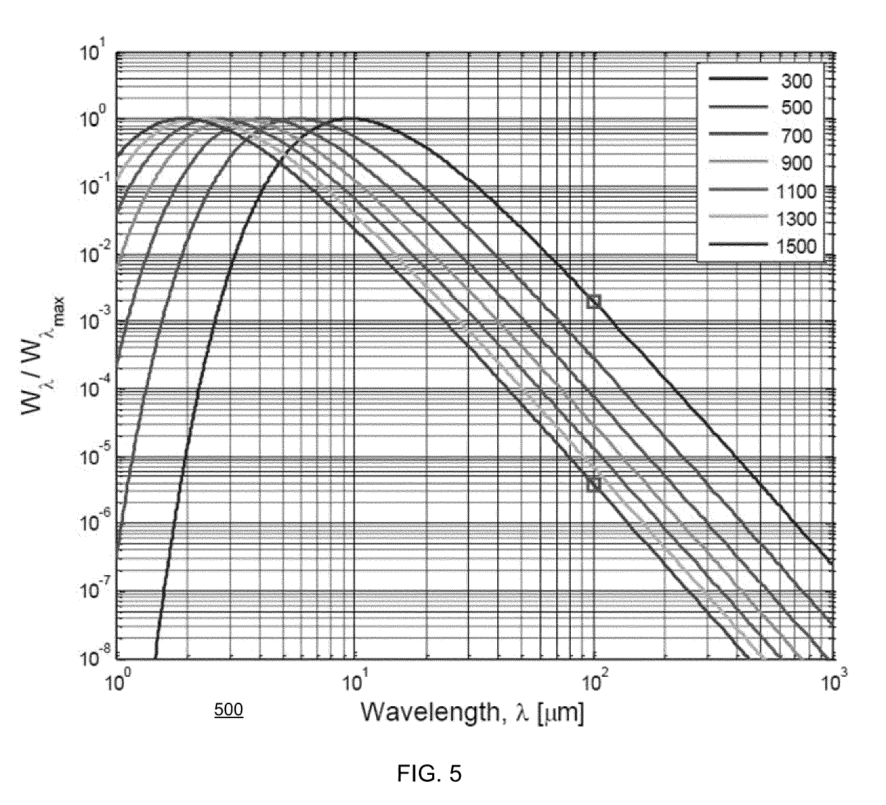

FIG. 5-19 form an integral part of Appendix A of the specification.

FIG. 5 is a graph 500 that illustrates the spectral radiant emittance normalized by the peak emittance, for several temperatures. The ratio at 100 μm (3 TeraHertz) between the wanted TeraHertz and the blackbody peak radiation, for the two limiting blackbody temperatures (300K, 1500K) is marked by the red dots.

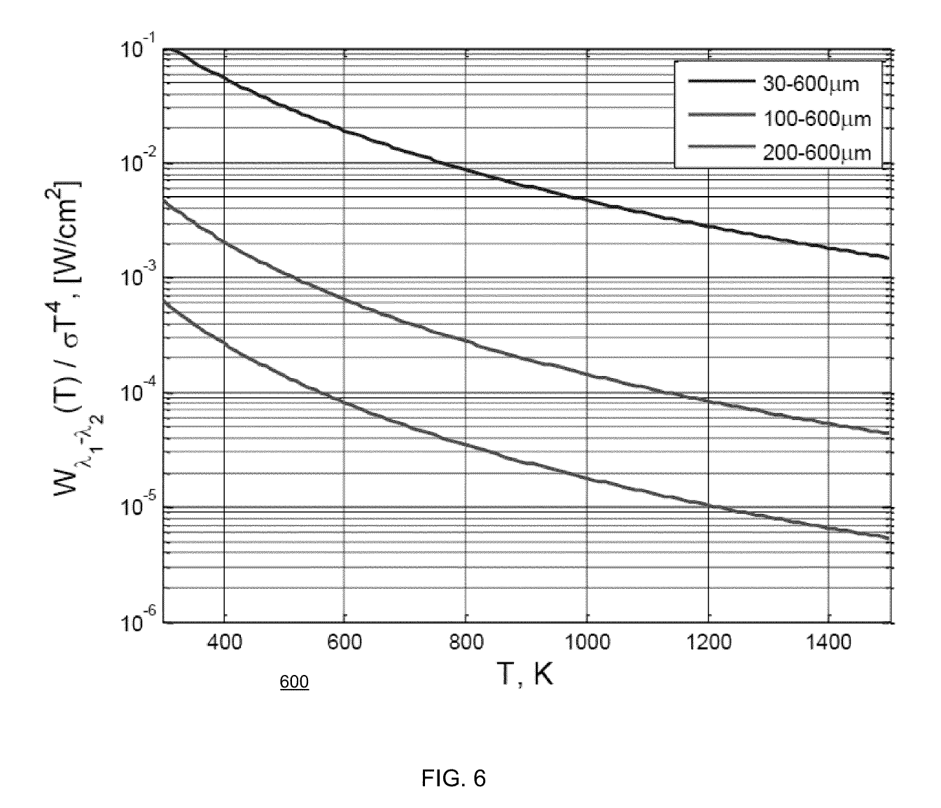

FIG. 6 is a graph 600 that illustrates normalized TeraHertz radiation, integrated over a given wavelength band corresponding to the designed sensor and total emitted radiation.

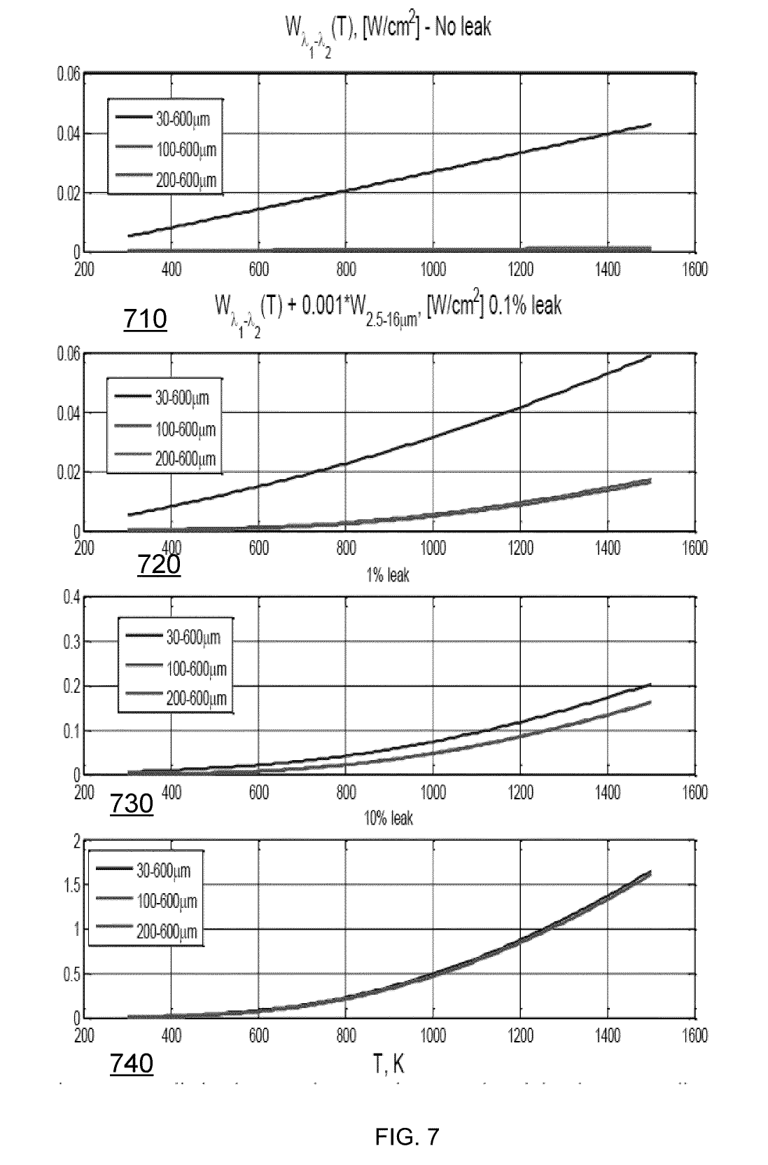

FIG. 7 includes three graphs 710, 720 and 730 that illustrate TeraHertz radiation integrated over a given wavelength band corresponding to the designed sensor and a “leak” of several percent of infrared radiation on a linear scale.

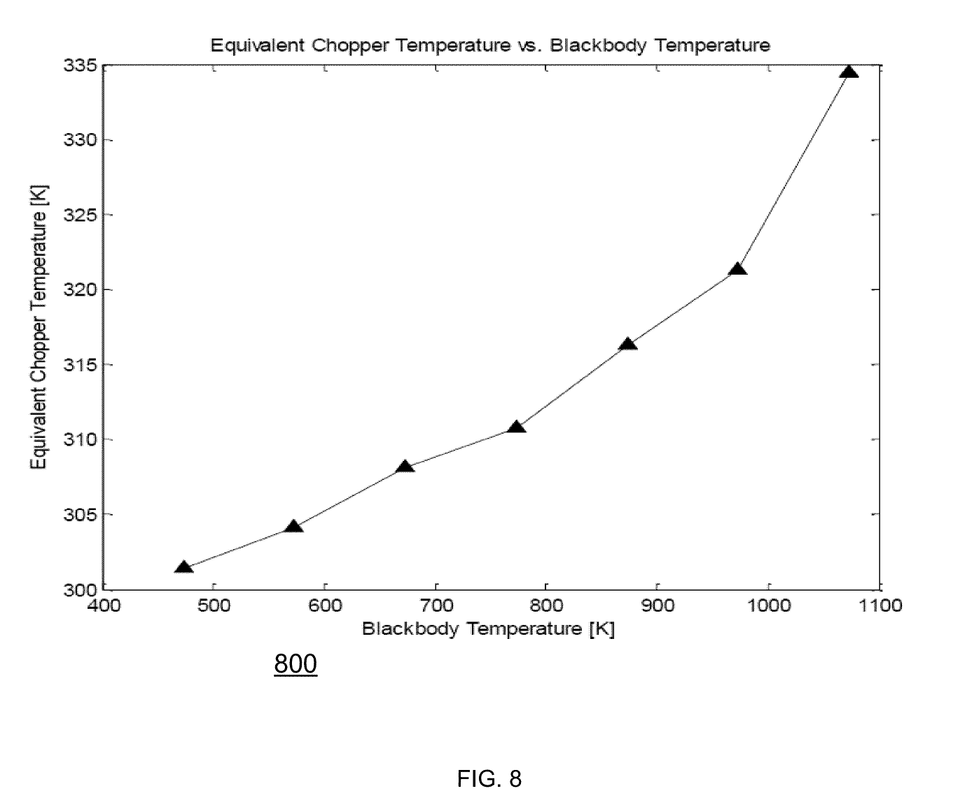

FIG. 8 includes a graph 800 that illustrates a calibration of the equivalent chopper temperature versus blackbody temperature.

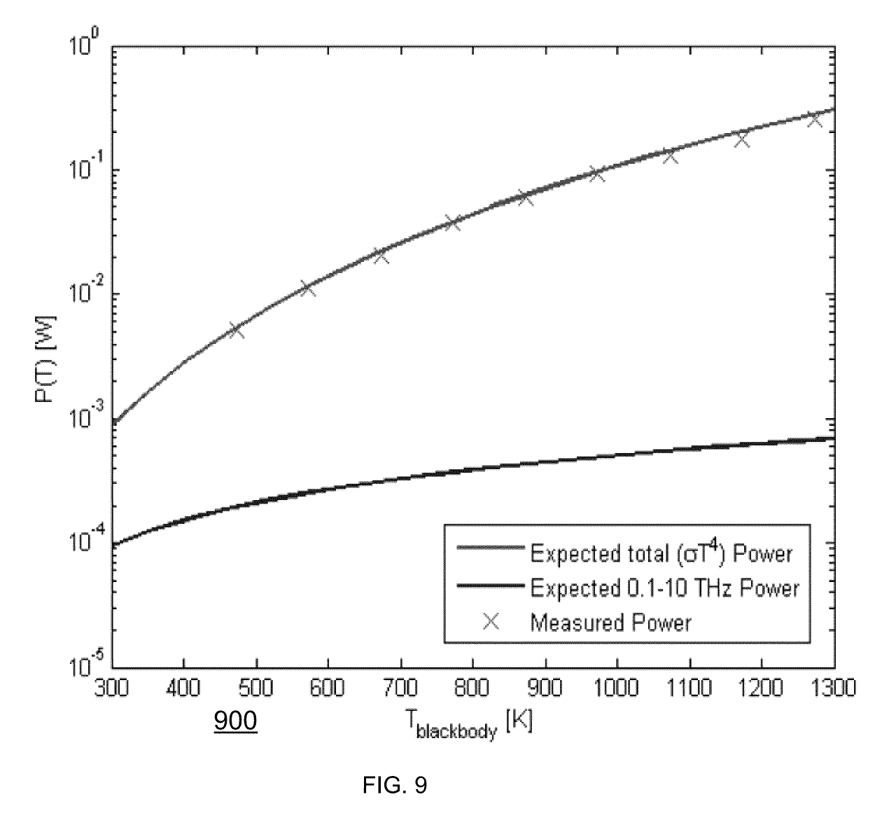

FIG. 9 includes a graph 900 that illustrates measured blackbody power using the calibrated commercial power meter [11], as a function of the blackbody temperature, without any filter. Blue: Expected TeraHertz power between 0.1-10 TeraHertz according to equation (5). Red x: Measured power. Black: Expected power according to Stefan-Boltzmann Law P=σT⁴ and equation (6).

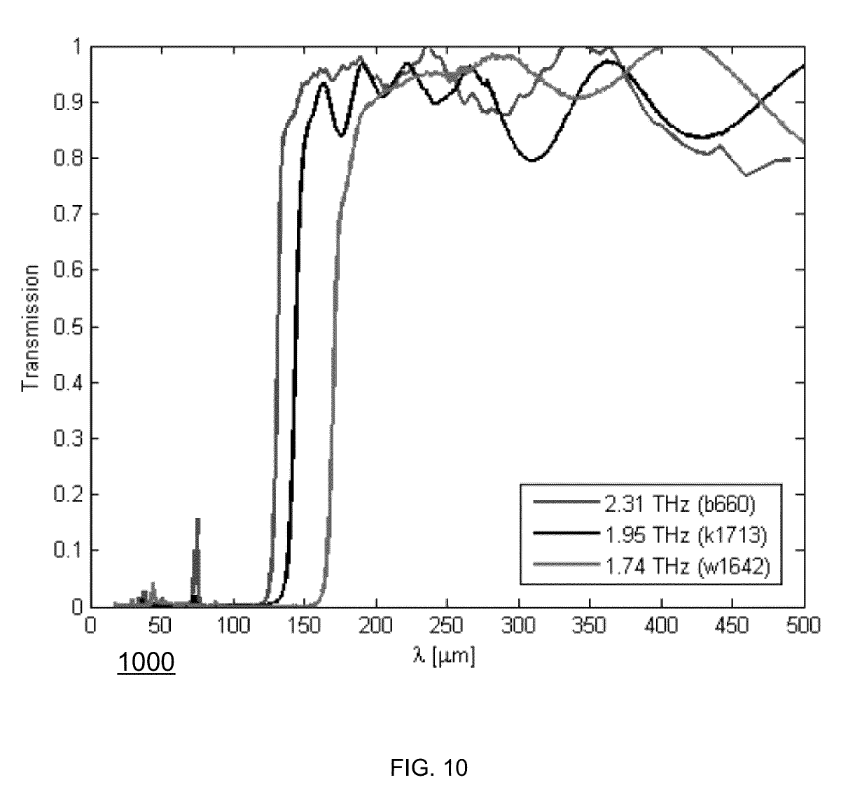

FIG. 10 includes a graph 1000 that illustrates mesh filter transmission measured by an evacuated spectrometer.

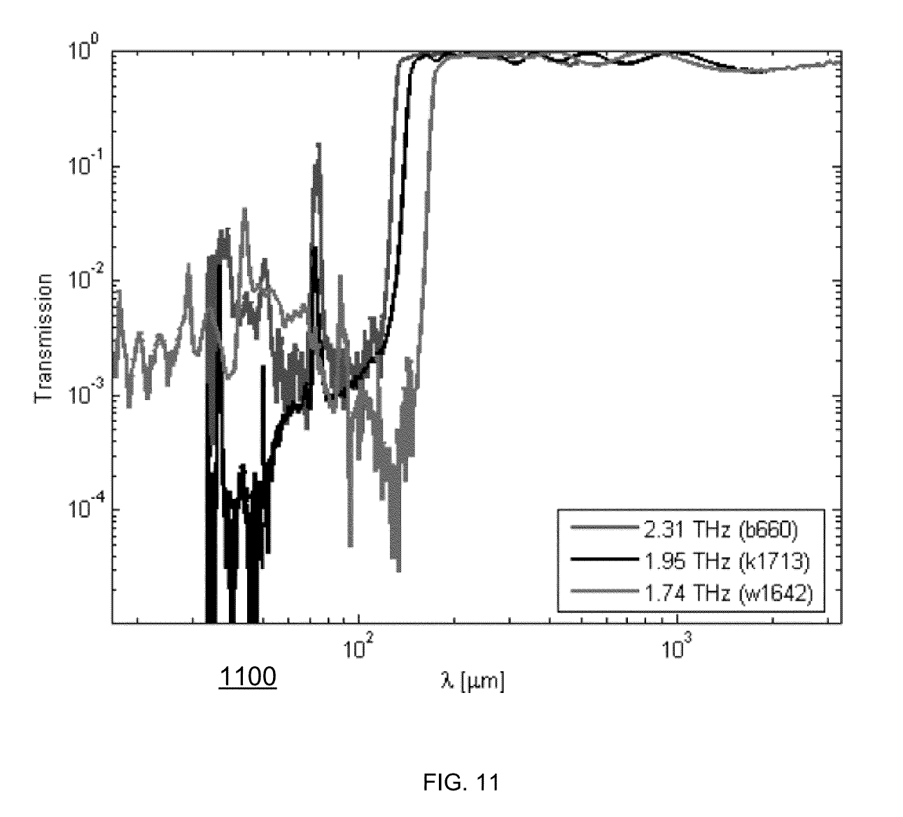

FIG. 11 includes a graph 1100 that illustrates the mesh filters transmission (logarithmic scale) vs. wavelength, measured in a spectrometer, indicating the attenuation at IR and visible regions.

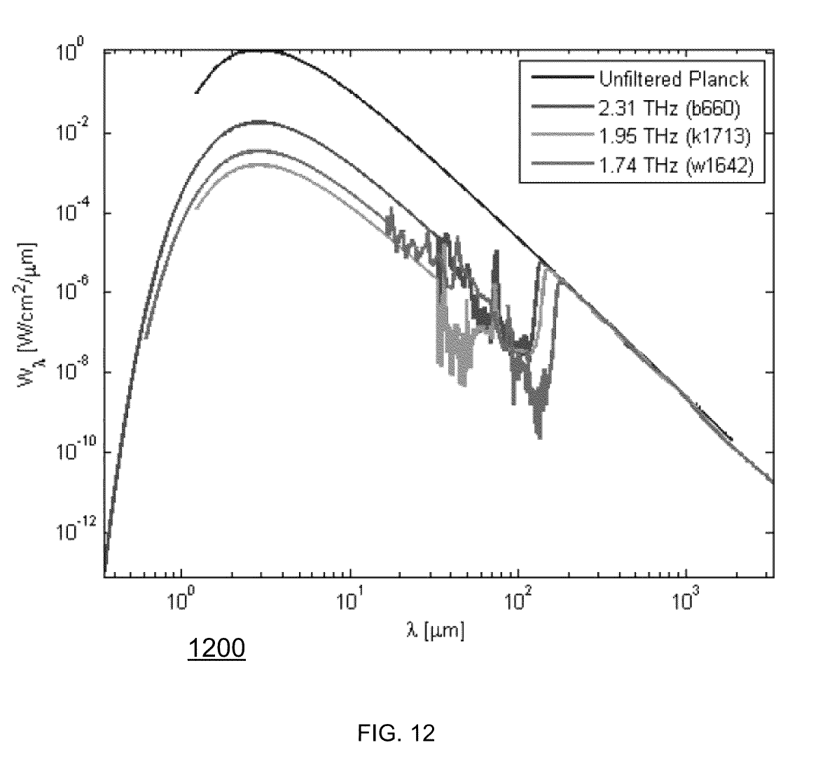

FIG. 12 includes a graph 1200 that illustrates a Spectral radiant emittance of a blackbody at T_{BB}=1000K, filtered with various filters and compared to the unfiltered emittance.

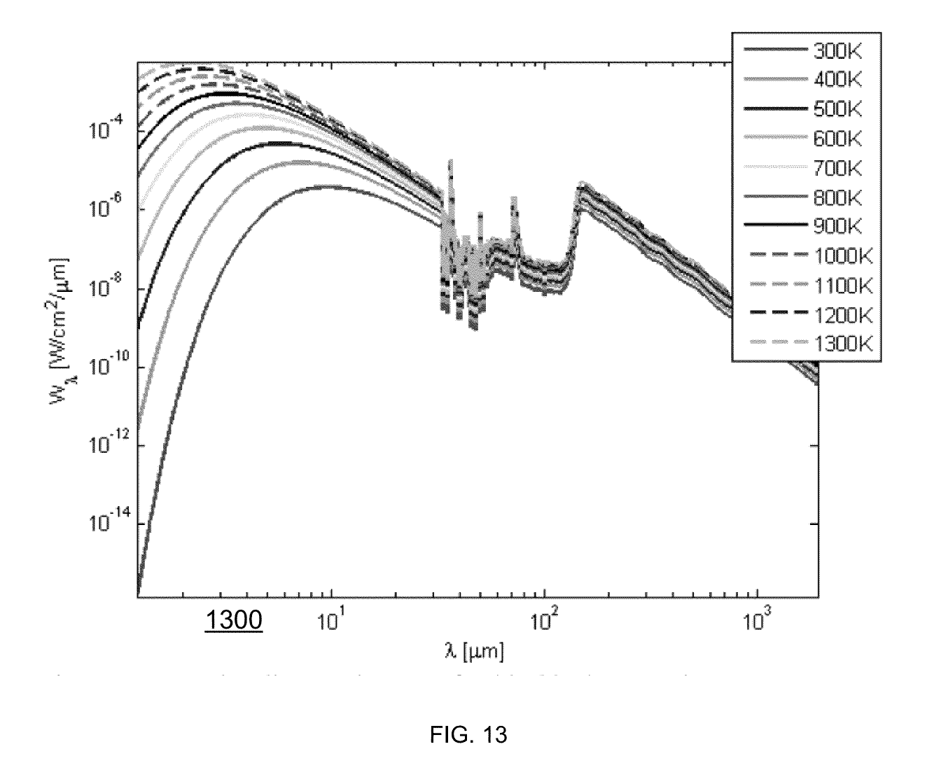

FIG. 13 includes a graph 1300 that illustrates a Spectral radiant emittance of a blackbody at various temperatures, filtered by a QMC K1713 (1.95 TeraHertz) filter.

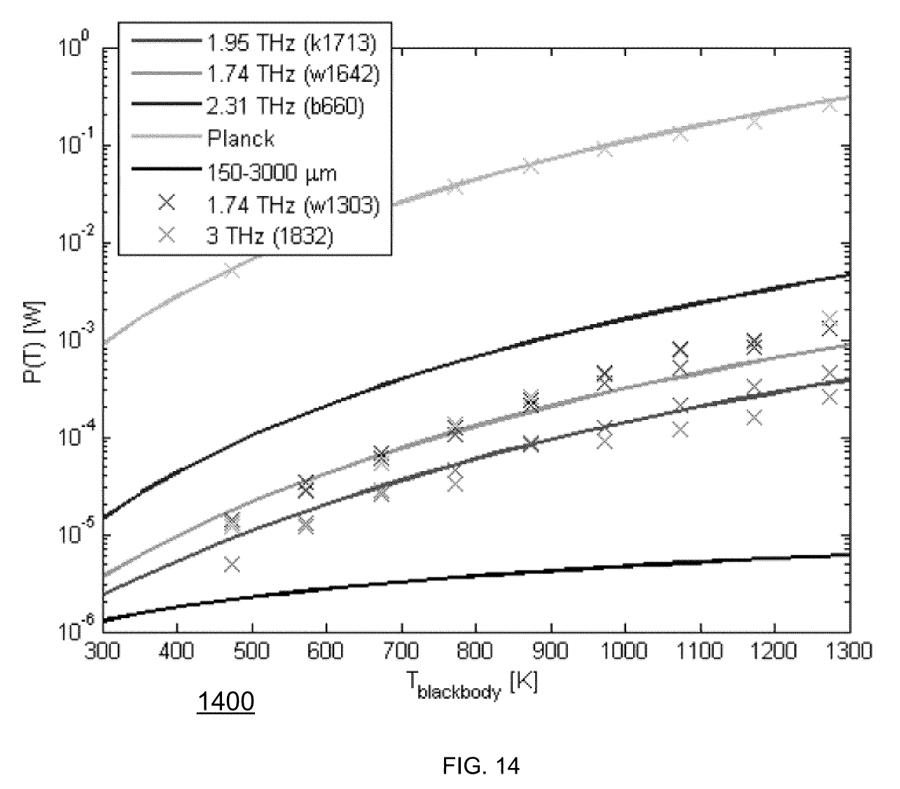

FIG. 14 includes a graph 1400 that illustrates a comparison of expected and measured power by the Ophir sensor. Solid lines represent calculated expected power, based on measured filer transmission, crosses represent measured power.

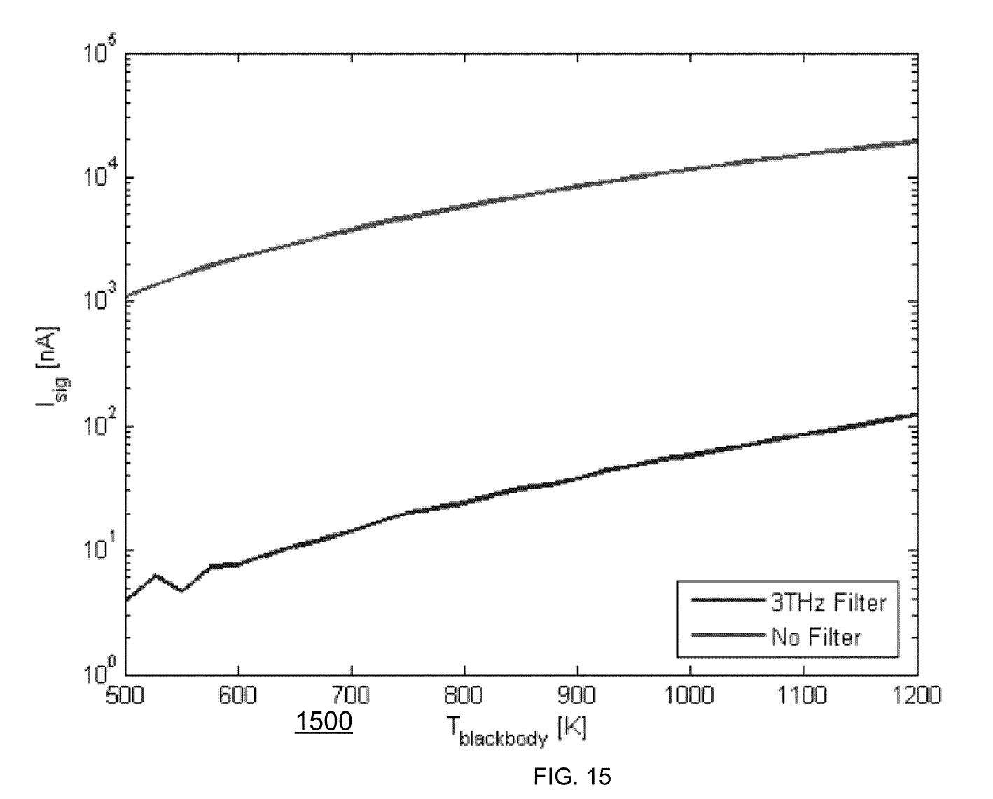

FIG. 15 includes a graph 1500 that illustrates the measured signal current of TMOS sensor with and without the Mesh filter. The filter IR radiation attenuation is 5·10⁻³.

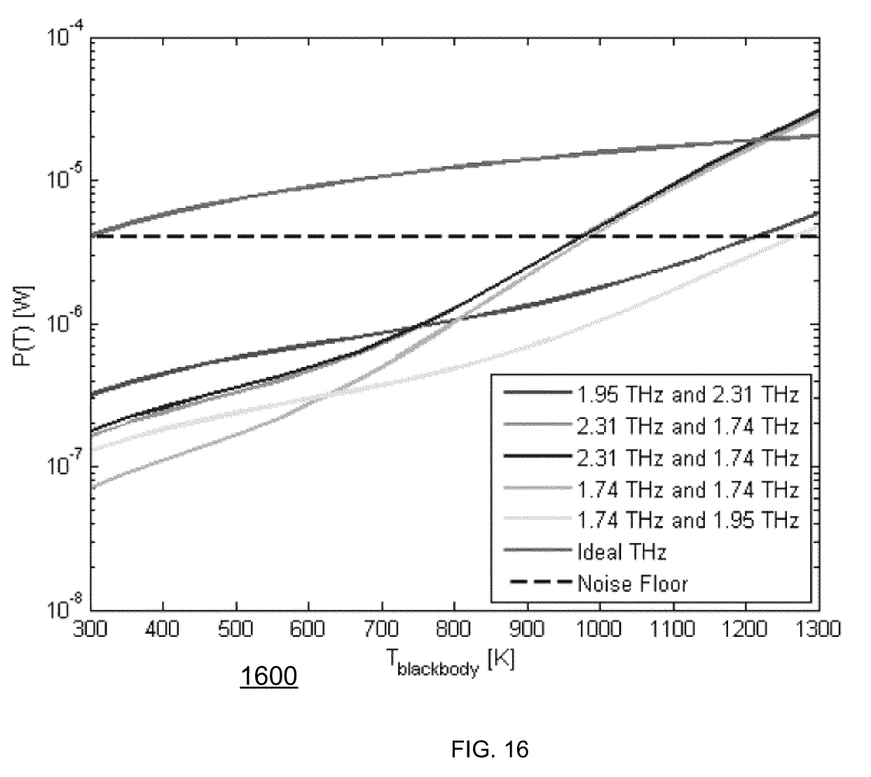

FIG. 16 includes a graph 1600 that illustrates the expected power with various two filter combination at f/2 and in a 6.4 millimeter aperture. The dashed line is the Ophir power sensor noise floor, “Ideal TeraHertz” is the calculated power within 100-600 micron.

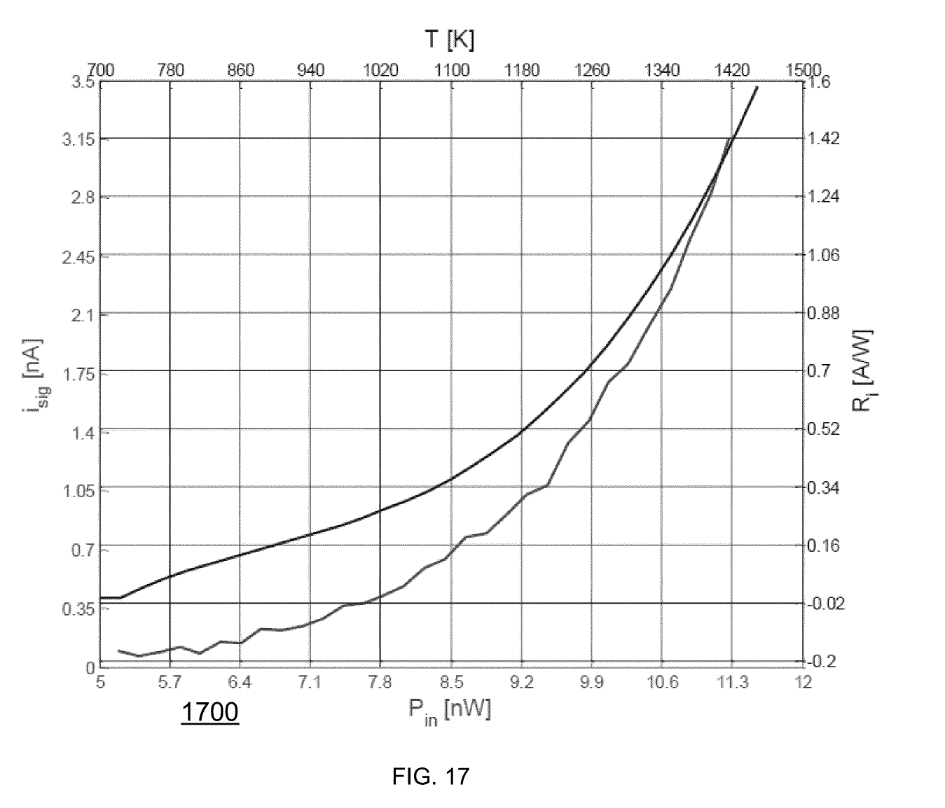

FIG. 17 includes a graph 1700 that illustrates measured signal current (red) and responsively (blue) vs. blackbody temperature and radiation power at chopper frequency of 1 Hz for the small array of sensors under study.

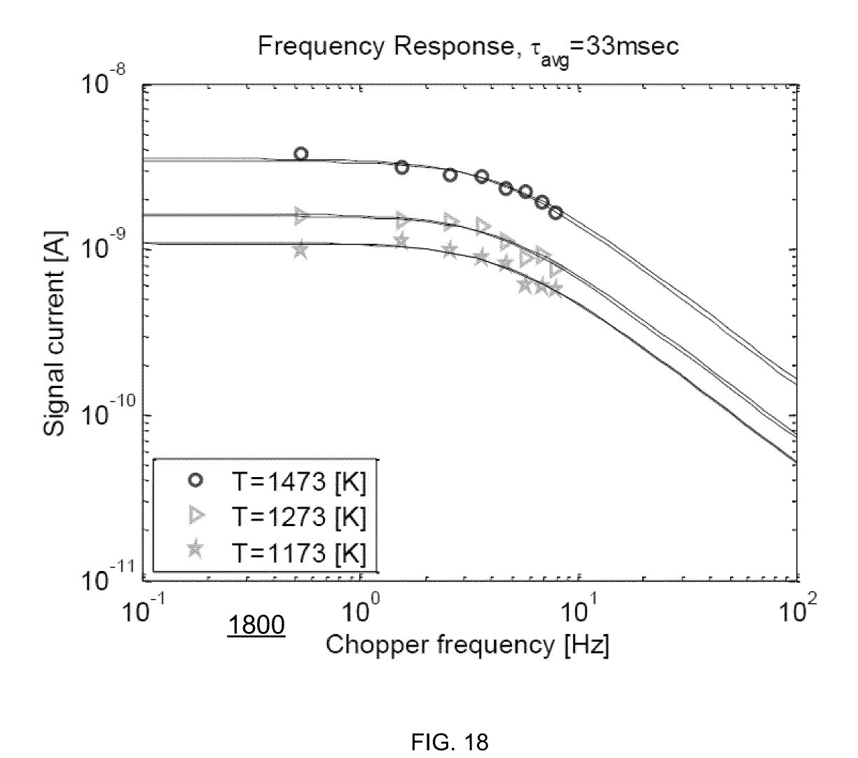

FIG. 18 includes a graph 1800 that illustrates a measured signal current vs. chopper frequency for several temperatures of the blackbody. The operation current of the TeraMOS sensor is I˜24 μA. The fitted τ_{th,eff}˜33 msec.

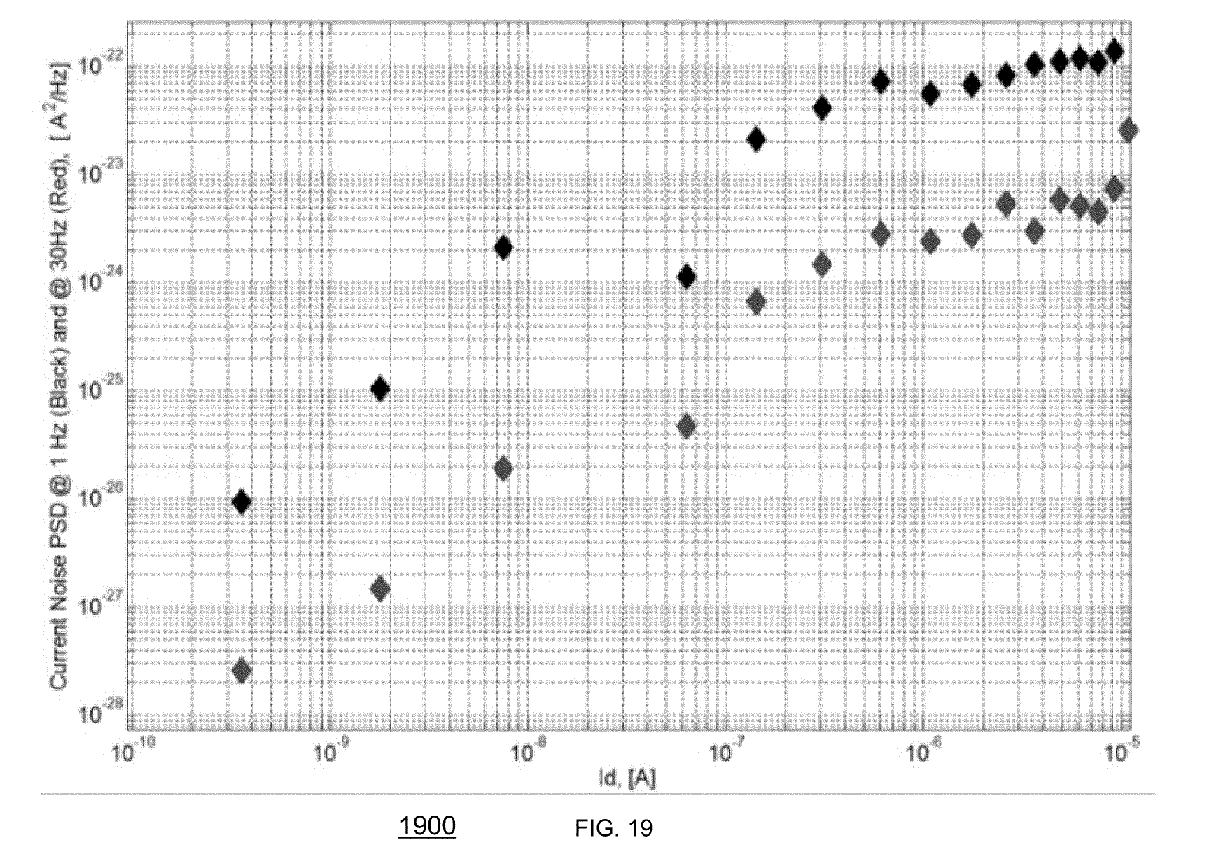

FIG. 19 includes a graph 1900 that illustrates the noise PSD of the small array under study as 1 Hz (black) and 30 Hz (Red).

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

### Appendix A

Abstract—This paper presents a low cost measurement setup for THz applications, based on a blackbody source, which is a commercial off-the-shelf (COTS) component. This measurement approach resembles the natural operating conditions of passive imaging systems and hence is more adequate in the characterization of the operation of THz sensors and filters for passive systems than narrow band THz sources. The calibration methodology of mesh filters that may block the unwanted IR radiation as well as that of THz thermal sensors is discussed. The components for uncooled passive thermal imaging: the innovative CMOS-SOI-NEMS thermal sensor (the TeraMOS) as well as mesh filters are characterized in the measurement setup presented here. The TeraMOS sensor reported here is a small array of 4×4 pixels, each 100×100 (μm)², with CMOS transistors with W/L=2/40, which are electrically connected but are thermally isolated. With NEP of the order of NEP/√Hz|_{1 Hz}=10 pW/√Hz, D* of 0.2·10¹⁰ cm√Hz/Watt and evaluated NETD of ˜0.2K. The corresponding NETD of a single pixel is ˜0.8K indicating that this uncooled THz sensor in standard CMOS-SOI technology may enable monolithic uncooled passive THz imagers.

### I. Introduction

As active and passive THz real-time imaging and spectroscopy systems operating at terahertz frequencies continue to evolve [1-8], increasing attention is being directed towards the calibration of filters and sensors at terahertz frequencies. Active systems are usually based on narrowband THz sources, such as lasers or spectrometers. Passive imaging systems require the acquisition of broadband THz signals in the presence of large background radiation. This work describes a THz measurement setup and the calibration methodology of filters and thermal THz sensors, based on a blackbody source, which more adequately characterizes the real operation of passive THz imagers.

The THz band of the electromagnetic spectrum bridges the gap between mm-waves and mid/far IR. By practical conventions this is often defined in the 0.3 THz (3 mm) to 10 THz (30 μm) frequency range. A narrower frequency range may also be defined, starting with 0.6 THz, since this is the highest operating frequency for CMOS circuitry in silicon-based technologies that are suitable for mass production [9].

Technology in the THz band is finding new and important applications in several key sectors such as medicine, security, chemical and biological imaging, aerospace and atmospheric sensing [8]. The actual application defines the frequency range of interest within the THz band. For example, if the main goal is an imager to be used for concealed weapons detection, then passive THz imagers may focus on a 0.6-3 THz band, or even on a narrower band 0.6-1.5THz [9].

A blackbody at ˜1200° C. provides THz radiation on the order of ˜μW, but that is a broadband source. When performing experiments using a well-defined, narrowband, THz source [10], there are practically no unwanted signals that may cause damage or introduce errors in the detection and calibration setup. However, when the THz radiation is from a broadband source such as blackbody, radiation in other bands, such as NIR, LWIR and VIS, dominates the power. Hence, it is required to filter the other undesirable components in a suitable manner. It is evident that in order to calibrate THz sensing systems there is a need for calibrated sources, filters and sensors.

In this study we present our methodology which shows how to achieve this using a blackbody source and two types of sensors: a commercial calibrated power meter based on a thermal sensor [11, 12] and the recently reported TeraMOS uncooled sensor for passive imaging [13], using several mesh filters [14]. In section II we address the blackbody as a calibrated THz source and revisit Planck's radiation law, which enables us to define the filter requirements as well as the preferred temperature range for the blackbody source. In section III we present the measurement setup. Further, in sections IV and V we give an account of a calibrated commercial thermal sensor used for the characterization of THz mesh filters in the blackbody setup. In section VI the methodology employed to characterize a novel, uncooled THz sensor for passive imaging dubbed TeraMOS [9, 13] is reported. Lastly, section VII summarizes this study.

### II. Blackbody as a Calibrated THz Source

Blackbody instrumentation is a commercial off-the-shelf (COTS) component, currently used mainly for providing calibrated IR radiation. However, the use of blackbodies as calibrated THz sources introduces a significant challenge: how to obtain the “wanted” THz radiation while filtering the unwanted radiation. This challenge is exhibited quantitatively by considering the ideal blackbody Planck radiation law:

$${W}_{λ} ( λ , T ) = \frac{2 π {hc}^{2}}{{λ}^{5}} \frac{1}{exp ( hc / λ kT ) - 1} [ \frac{Watt}{{cm}^{2} \cdot μ m} ] \qquad ( 1 )$$

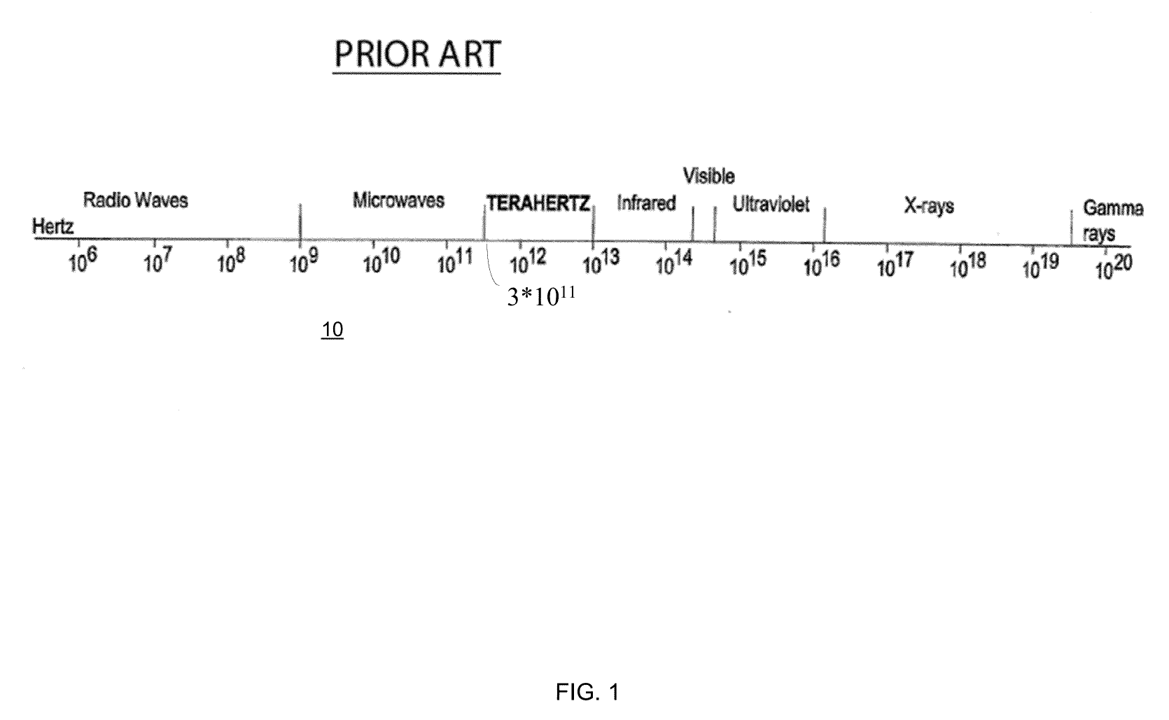

FIG. 1 exhibits on a log-log scale the spectral radiant exitance, expressed in [W/cm²/μm] and normalized by the peak exitance at λₘₐₓ, as a function of the wavelength, for several relevant temperatures. On a log-log graph, the following can be easily seen:
Firstly, the shape of the blackbody radiation plot is the same for any temperature.
Secondly, at higher temperatures the normalized plot is simply shifted to lower wavelengths.
Thirdly, it is evident that in the THz band, the spectral radiant exitance is several orders of magnitude lower compared to that of the peak exitance. The ratio between the “wanted” THz radiation and the blackbody peak radiation decreases between 2·10⁻³ to 4·10⁻⁶ as the blackbody temperature increases between 300K and 1500K.

Blackbody radiation may be divided into two limiting cases: (i) high temperatures and long wavelengths (ii) low temperature and shorter wavelengths. The former case clearly corresponds to THz radiation at room temperature and above it, while the latter case corresponds to IR radiation below ˜10 μm, at the temperature range under study (300-1500 K).

In the THz range, at temperatures >300K, the Rayleigh-Jeans approximation holds. According to this approximation, hc/λkT<<1 and exp(hc/λkT)=1+(hc/λkT). Hence,

$${W}_{λ} ( λ , T ) [ \frac{Watt}{{cm}^{2} \cdot μ m} ] \approx \frac{2 π ckT}{{λ}^{4}} \qquad ( 2 )$$

The radiant exitance W_{λ}_{₁}_{-λ}_{₂} (T), namely (1) integrated between λ₁ and λ₂, may be readily calculated either by numerical integration of (1) or by analytical integration based on (2), which introduces only a small error.

A useful presentation is shown in FIG. 2, where the THz radiation in the relevant band defined by λ₁ and λ₂ is exhibited, normalized by the total emitted radiation, as determined by Stefan-Boltzmann law −σT⁴, where σ=5.67·10⁻¹² [W·cm⁻²·K⁻⁴]. The three plots of FIG. 2 are calculated for different λ₁ but the same λ₂=600 μm. It is evident from FIG. 2 that the ratio of the “wanted” THz radiation is mainly affected by the shorter wavelength, decreasing by two orders of magnitude as λ₁ changes from 30 μm to 200 μm.

While measurements are performed using a blackbody as the source and applying practical filters and thermal sensors, a “leak” of a few percent of IR radiation may irradiate the sensor. FIG. 3 exhibits such a case on a linear-linear scale, assuming a “leak” of 0.1%, 1% and 10% of the peak radiation around λₘₐₓ. It is evident that the “leak” affects the linearity predicted by (2). The functional dependence on temperature now becomes strongly dependent on the assumed percent of the “leak” as well as its assumed band. It is evident that IR “leak” strongly influences the emitted radiation in the longer wavelengths.

In conclusion to this section, several interesting observations may be deduced just by noting the dependence of the measured sensor signal on temperature:

1) While using a blackbody source for calibration, regardless of the specific type of thermal sensors or filters used, the sensor provides a response signal (i_{sig} or P_{sig} after calibration) while the blackbody controlled parameter is the temperature (T_{BB}). In the THz wavelengths, Planck's law may be easily manipulated to yield the Rayleigh-Jeans approximation. Accordingly, a linear dependence between the measured signal and temperature is expected, provided the sensor is linear.

2) However, if there is a “leakage” of shorter wavelengths, on a linear-linear scale, this linearity degrades.

3) By noting the functional dependence of the measured signal upon temperature, the “leakage” can be characterized and its source may be evaluated, this only in the case that the sensor response is known to be linear.

4) Since thermal sensors are known to be non-linear [15], the sensor response vs. the blackbody temperature will not be linear, even if there is no “leak”, as will be discussed in section VI and Appendix B.

### III. The Measurement Setup

A measurement approach, which resembles the natural operating conditions of passive imaging systems, is based on a calibrated cavity blackbody, operating in the 300-1200° C. (573-1473K) range as the THz source (CI Systems SR-200). Since at these temperatures the emission peak of the blackbody lies in the IR range, a THz low-pass mesh filter, with a sharp cutoff at the required frequency is used to remove the unwanted radiation [14].

The complete setup depends on the nature of the sensor. In this study a CMOS-SOI-NEMS sensor termed TeraMOS [13] is characterized while a commercial thermopile sensor [11] is used to calibrate the chopper and the filters.

The measurement setup is shown in FIG. 4. Two parabolic 90° off-axis gold mirrors with f#=1 and 76.2 mm diameter provide the optical path. By varying the blackbody temperature the incident THz power is varied.

In the case of the TeraMOS, the current response i_{sig} as a function of chopper frequency is measured for several blackbody temperatures T_{BB} (i_{sig} vs. T_{BB}). In addition to the mesh filter, the unwanted radiation is filtered by an antenna, which is part of the sensing pixel [13] and is partially filtered by the optical window of the sensor. The pixel thermal antenna is designed to absorb in the required THz band by tailoring its perimeter to the THz wavelength of interest (200 μm in the case of the pixel described in [13] and 100 μm in the case of the sensor reported in section VI).

The incident radiation is modulated by a mechanical chopper varying in frequency between 1-15 Hz. The pixel is biased at a constant voltage. The ac current signal is fed into a low noise trans-impedance amplifier (Stanford Research Systems SR 570), whose output is then measured by a lock-in amplifier (Ametek 7270), with the chopper frequency as a reference signal. The incident radiation is obtained by

$${P}_{THz} = ɛ \frac{{A}_{d}}{4 {f}_{\#}^{2} + 1} \cdot CFF \cdot {\int }_{{λ}_{1}}^{{λ}_{2}} {W}_{λ} ( λ , T ) {τ}_{filter} ( λ ) {τ}_{opt} ( λ ) d λ \qquad ( 3 )$$

where λ₁ and λ₂ are determined by the bandwidth of the pixel antenna provided by HFSS simulations as well as the cut-off frequency of the THz filter. CFF=0.45 is the chopper forming factor in the case of a square wave, ε=1, f#=1, A_{D} is the area of the detector. We assume 100% reflectance for the gold mirrors. The overall optics transmission is determined by the transmission corresponding to the THz bandpass of the filters τ_{filter} as well as that of the fused quartz window τₒₚₜ, which presently does not have any AR coating.

The basic operation of the chopper may be described by two phases: the “closed” phase where the chopper is opaque and the “open” phase where it is transparent. In the former case the chopper shields the sensor from the blackbody radiation while in the latter case the sensor detects the radiation emitted by the blackbody aperture. The effective measured signal is the difference between the chopper temperature and the blackbody temperature. During the open phase the sensor temperature fractionally but nevertheless significantly increases to what it would be for an unchopped system. The amplitude of the signal is given by (see Appendix B and [13]):

$${i}_{sig} ( f ) = \frac{{i}_{sig} ( DC )}{\sqrt{1 + {( 2 π f \cdot {τ}_{th , eff} )}^{2}}} \qquad ( 4 )$$

where f is the chopper frequency and τ_{th.eff} is the effective time constant. If an opaque chopper is operating at a temperature that is substantially different from the blackbody temperature, the large signals generated can exceed the capability of the gain correction algorithm [16]. In that case, the gain of the trans-impedance amplifier cannot simultaneously accommodate the reading in the “open” phase, which is large and in the “opaque” phase, which is low. The result is an offset that varies with the blackbody temperature. In such cases, the actual signal should be calculated as the difference between the power emitted by the blackbody at the “open” phase and the power emitted by the chopper blade at the “closed” state, assuming that the effective chopper temperature is known.

FIG. 5 indicates that the effective chopper temperature increases only by several tens of degrees, and therefore it has a minimal effect on the measurement.

### IV. Commercial Thermopile Sensor [11, 12]

A commercial calibrated thermopile sensor is used to calibrate the chopper and the filters [11]. The main advantage for the setup under study of this very slow sensor is that it operates practically at DC and hence does not require a chopper. Thus, it can be readily used to calibrate the chopper effective temperature at its two idle positions. Furthermore, the commercial sensor is calibrated and hence the measurement directly yields P_{sig} vs. T_{BB}. Ophir Optronics 3A-P-THz power/energy sensor [11] for measuring at THz wavelengths has been calibrated to measure THz radiation at the Physikalisch-Technische Bundesanstalt (PTB) National Metrology Institute in Germany It measures short pulse or CW lasers in the 0.3-10 THz wavelength range, corresponding to 30-1000 μm [12].

The sensor's p-type absorber provides a larger aperture and a more flat spectral response than most similar devices, maximizing performance across the entire THz spectral range. The calibration was verified in two additional academic institutes, at the Ariel University in Israel and at RPI in the US [17]. In all the three calibration sites, the THz radiation was provided by narrow band THz sources [10] and therefore the fact that the sensor may absorb IR radiation did not affect the accuracy of the results.

TABLE I
metal mesh filters under study

| Wavenumber | Wavelength | Frequency |
|---|---|---|
| ν[cm⁻¹] | λ[μm] | f [THz] |
| 107 | 93 | 3.21 |
| 77 | 130 | 2.31 |
| 65 | 154 | .95 |
| 58 | 172 | 1.74 |
| 58 | 172 | 1.74 |

During measurements using the commercial power sensor, it was placed at the focal plane of the optical system, in place of the dewar, as shown in FIG. 4. Where applicable, filters were placed in front of the sensor. In such a setup, the sensor area for the purpose of power calculations is defined either by the commercial sensor aperture (11.2 mm diameter) or the blackbody variable aperture setting - whichever is the smaller of the two.

FIG. 6 exhibits the measured power of the blackbody in the “open” state using the commercial power meter as a function of the blackbody temperature, without any filter. The measured power with the Ophir sensor [11], at different blackbody temperatures, while the chopper was in the “open” state was compared with analytical calculations, assuming different bandpass wavelengths.

Assuming 0.1-10 THz radiation, according to integration of Planck's Law, the expected power (blue plot of FIG. 6) is:

$${P}_{THz} = {\int }_{30 μ m}^{3000 μ m} {W}_{λ} ( T ) d λ \cdot {A}_{aperture} \cdot \frac{1}{4 {f}_{\#}^{2} + 1} \qquad ( 5 )$$

According to the Stefan-Boltzmann Law, the expected power (red plot of FIG. 6) is:

$${P}_{tot} = σ {T}^{4} \cdot {A}_{aperture} \cdot \frac{1}{4 {f}_{\#}^{2} + 1} \qquad ( 6 )$$

There is nearly perfect matching between the measured power and the expected Stefan-Boltzmann power, which indicates that the commercial sensor absorbs radiation, effectively, in all frequencies above the THz range. Thus, the calibrated 0.1-10 THz power holds true only for narrow band THz sources [10].

### V. Filters

An important component of a THz imaging system is the filter, which is designed to transmit THz radiation while blocking unwanted IR radiation. Choosing a good filter is a requirement for both for the passive imaging system and as part of the measurement and testing process. Table I summarizes several filters which were investigated and measured [14]. All are low-pass filters (in terms of frequency), and their nominal cut-off frequencies/wavelengths are listed.

The spectral transmission data of several of the filters was provided by the vendor [14] (see Appendix A). FIG. 7 summarizes the spectral transmission on a linear scale, illustrating the cut-off wavelengths and roll-off, as measured independently, in a non-evacuated spectrometer, after prolonged exposure to the blackbody.

It is evident form FIG. 7 that the transmission of the filters under study around the shorter wavelengths, for example 100 μm, is less than 0.30. FIG. 2 (section II) illustrates that the THz power provided by the blackbody is determined by the shorter wavelength. Hence, these filters significantly attenuate the THz power around their nominal wavenumber.

To clearly illustrate the stop-band behavior, the reader is referred to FIG. A.1 at Appendix A. Using the measured spectral transmission and Planck's Law (1), we calculate the expected filtered spectral radiant exitance of the blackbody source. This allows us to estimate the degree of IR attenuation the filter achieves when used in front of a blackbody. FIG. 8 depicts a comparison between unfiltered blackbody spectral radiant exitance, at T=1000K, and the spectral radiant exitance multiplied by the transmission of the various filters, as described by

W_{filtered}(λ,T)=W(λ,T)·t_{filter}(λ) (7)

It can be seen that at T=1000K, the transmitted IR radiation is significantly more powerful than the THz radiation, using any of the filters. The peak spectral radiant exitance is about three orders of magnitude larger than the spectral radiant exitance at 100 μm (3 THz).

However, for lower temperatures, closer to 300K, the spectral radiance ratio between IR and THz is less severe, as shown in FIG. 9. FIG. 9 presents the filtered spectral radiance, for a particular filter (1.95 THz), for varying temperatures. The results of FIG. 9 indicate that for uncooled passive thermal imaging at ambient temperature of 300K, the filters provide adequate, attenuation of the IR when taking into consideration the additional filtering provided by the optical window and the antenna of the THz sensor (see section VI].

In the blackbody measurement setup, in contrast to the spectrometer, the radiation is non-polarized and is incident from various angles, in particular in low f# optics. Hence, it is important to cross-validate the evacuated spectrometer results, and to check if the filter responds as expected to radiation incident from various angles in the non-evacuated system under study, which is typical to passive uncooled systems.

Accordingly, the performance of the filters is also characterized in the blackbody measurement setup, in a setup which corresponds to the application of uncooled passive thermal imaging. Two sensors are used: the commercial power sensor [11, 12] as well as a more sensitive uncooled IR sensor, termed TMOS [18].

The expected power received by the commercial sensor, from a blackbody source with a filter in the radiation path is given by:

$$P ( T ) = {\int }_{{λ}_{1}}^{{λ}_{2}} W ( λ , T ) {t}_{filter} ( λ ) d λ \cdot {A}_{aperture} \cdot \frac{1}{4 {f}_{\#}^{2} + 1} [ W ] \qquad ( 8 )$$

where W(80 , T) is the Planck spectral radiant exitance, according to (1). The integration limits are the wavelength limits of the measured spectral data (roughly 0.5-200 μm). Assuming that the commercial power meter [11] absorbs radiation in all frequencies, the power absorbed without a filter would be described by:

$${P}_{no filter} ( T ) = σ {T}^{4} \cdot {A}_{aperture} \cdot \frac{1}{4 {f}_{\#}^{2} + 1} [ W ] \qquad ( 9 )$$

where σ is the Stefan-Boltzmann constant, according to the Stephan-Boltzmann law.

Equations (8) and (9) are calculated using MATLAB and applying the filters measured spectral transmission data. The results are then compared to the measurements made using the commercial sensor. The comparison may be seen in FIG. 10. Also appearing in the figure is the expected power had there been an ideal 100-600 μm (0.5-3 THz) filter in place (labeled ‘Ideal THz’), calculated according to:

$${P}_{THz} = {\int }_{100 μ m}^{600 μ m} W ( λ , T ) d λ \cdot {A}_{aperture} \cdot \frac{1}{4 {f}_{\#}^{2} + 1} [ W ] \qquad ( 10 )$$

In FIG. 10, the solid lines represent the calculated expected power while the cross marks represent measurement points. For almost all filters we see a good match between the calculated expected power and the measured power

The filters performance is evaluated by comparing the measured results to the ‘100-600 μm’ plot, which represents power through an ideal 0.5-3 THz filter. It is evident from FIG. 10 that for blackbody temperatures above ˜500K, the measured power transmitted through the filters is significantly higher than predicted. This is in accordance with the predictions of FIG. 2 and the results of FIGS. 8, 9: the IR component is too strong compared to the THz component to be sufficiently filtered by any single mesh filter. On the other hand, for blackbody temperatures below ˜500K, the filters attenuation is likely to be sufficient to block the unwanted IR radiation in an imager, where further filtering of the IR is provided by the optical window and the sensor's antenna. The THz power in the 100-600 μm band is only between ˜4 μW at ˜300K and ˜20 μW at ˜1300K, while the noise floor of the commercial sensor is ˜4 μW. Hence, a more sensitive sensor is required to characterize the attenuation of the mesh filters at lower blackbody temperatures and at IR wavelengths. We therefore further characterized the 3 THz mesh filter using a sensitive uncooled IR sensor, dubbed TMOS, developed at the Technion-Israel Institute of Technology [18]. The TMOS is packaged in a Dewar with a Germanium optical window, equipped with an optical filter that transmits IR radiation between 8-14 μm. The measured signal current with and without the 3 THz filter is shown in FIG. 11. The results of FIG. 11 indicate that the IR signal is attenuated by the filter by a factor of 5·10⁻³, again indicating that for uncooled passive thermal imaging at an ambient temperature of 300K, the filters provide adequate attenuation of the unwanted radiation.

The option of using two filters simultaneously has also been considered. The expected transmitted power is obtained by multiplying the measured spectral transmission data of the two different filters:

$$P ( T ) = {\int }_{{λ}_{1}}^{{λ}_{2}} W ( λ , T ) \cdot {t}_{filter 1} ( λ ) \cdot {t}_{filter 2} ( λ ) d λ \cdot {A}_{aperature} \cdot \frac{1}{4 {f}_{\#}^{2} + 1} [ W ] \qquad ( 11 )$$

The results can be seen in FIG. 12, along with the expected power through an ideal 100-600 μ(m filter (10). It is evident from FIG. 12 that two filters would indeed better block the unwanted radiation but additionally would strongly attenuate the THz radiation, indicating that the use of such filtering may be non-practical in the non-evacuated blackbody setup. In conclusion, should the additional filtration provided by the optical window as well at the sensor level by the sensor thermal antenna [13] be taken into account, the use of a single mesh filter will be sufficient for passive, uncooled operation at room temperature.

### VI. TeraMOS Sensor Characterization Methodology

A novel nanometric THz senor implemented in CMOS-SOI-NEMS technology, dubbed TeraMOS, for passive uncooled imaging has been recently reported [13]. Below, the TeraMOS characterization methodology using the blackbody as the THz source is described. The TeraMOS sensor reported here is a small array of 4×4 pixels, each 100×100 (μm)², with CMOS transistors with W/L=2/40, which are electrically connected but are thermally isolated. The thermal isolation results from the post-processing nano-machining of the thermal antenna and TeraMOS sensor on each pixel [13]. Such an array provides a signal current, which is ˜16 times larger than that of a single pixel while the thermal time constant is that of a single pixel.

The measured signal current of the TeraMOS sensor as a function of blackbody temperature is shown in FIG. 13 as well as a function of chopper frequency is shown in FIG. 14. The measured signal current is the small variation that is due to the temperature rise following the absorption of the THz radiation, expressed as a function of chopper frequency, P_{THz}(f) and is given by [13]:

$${i}_{out} ( f ) = \frac{( \frac{\partial I}{\partial T} ) η {P}_{THz} ( f )}{{G}_{th , eff} \sqrt{1 + {( 2 π f {τ}_{eff} )}^{2}}} ( \frac{1}{1 + {g}_{m} ( {R}_{S} + {R}_{D} )} ) \qquad ( 12 )$$

Here the temperature derivative of the current is taken at the operating point and G_{th,eff} is the effective conductance that is obtained in case of self-heating that is due to Joule dissipation as well as other additional non-linear effects (Appendix B).

The incident THz power is obtained from

P_{THz}=(A_{D}/4ƒ_{#}²)CFF·τ_{optics}·τ_{filter}·∫_{λ}_{₁}^{λ}^{₂}W_{λ}(T)dλ (13)

For λ₁ and λ₂ we assume 90 and 200 μm respectively, this according to the bandwidth of the antenna provided by HFSS simulations as well as the cut-off frequency of the THz filter. CFF=0.45 is the chopper forming factor in the case of a square wave, ε=1, f#=1, A_{D}=16·10⁻⁴ cm² (the area of 16 pixels electrically combined in parallel). We assume 100% transmittance for the gold mirrors. The effective τ_{filter}=0.2 is determined by the transmission of the mesh filter (see FIG. 7). The effective τ_{optics}=0.2 is determined by the transmission of the fused quartz window (see FIG. A.2 of Appendix A) that does not have AR coating.

FIG. 13 yields the current responsivity, Rᵢ˜1 [A/W] and Rᵢ˜0.25 [A/W] at the higher and lower temperatures, respectively. It should be noted that the responsivity is significantly dependent on the blackbody temperature. This is a well-known effect for thermal sensors and results from the inherent non-linear nature of bolometers [15, 19, 20]. Since the TeraMOS, is an “active bolometer”, its responsivity is also non-linear. The non-linear effects are traditionally hidden in G_{th,eff} while operating at ambient temperatures of ˜300K. While performing in the presence of hot sources, such as the sun, these non-linear effects become apparent [19, 20].

The non-linearity of the TeraMOS is further characterized by measuring the responsivity of the TMOS of FIG. 11, in which the sensor is a nano-machined CMOS transistor with the same W/L=2/40 of the TeraMOS sensors that is under study here. The TMOS responsivity increases by a factor of ˜4.5 between 300K and 1400K. In the case of the TMOS the absorbed radiation is only the nominal 8-14 μm and hence the non-linearity of the signal cannot be attributed to “leakage” of IR radiation.

The measurements of FIG. 14 are fitted with (12), which directly yields the effective thermal time constant. For the TeraMOS small array of 4×4 pixels under study here, τ_{th,eff} is ˜33 msec, which is close to the measured value of a single pixel, as expected since the pixels are thermally isolated.

In a separate noise characterization setup, we measured the noise current at the operating point \sqrt{iₙ²} [21], which is exhibited in FIG. 15. Since at this stage we are not employing circuit noise reduction techniques, the 1/f noise is the dominant noise.

Below, the responsivity and noise performance of the array are compared to those of a single pixel. The parameters of a single pixel are marked with an apostrophe while the parameters of the array are without an apostrophe.

Accordingly, with N pixels:

$${i}_{sig} = {Ni}_{sig}^{′} \\ \overline{{i}_{noise}^{2}} = N \overline{{i}_{noise}^{2 ′}} \\ {P}_{sig} = {NP}_{sig}^{′} \\ A = {NA}^{′} \qquad ( 14 )$$

The current responsivity of the array is identical to that of a single pixel since:

$$\begin{matrix}{R}_{i} = \frac{{i}_{sig}}{{P}_{sig}} \\ = \frac{{Ni}_{sig}^{′}}{{NP}_{sig}^{′}} \\ = {R}_{i}^{′}\end{matrix} \qquad ( 15 )$$

The signal-to-noise ratio (in power) improves by N times:

$$\begin{matrix}SNR = \frac{{( {i}_{sig} )}^{2}}{\overline{{i}_{noise}^{2}}} \\ = \frac{{{N}^{2} ( {i}_{sig}^{′} )}^{2}}{N \overline{{i}_{noise}^{2 ′}}} \\ = N \cdot {SNR}^{′}\end{matrix} \qquad ( 16 )$$

The measured SNR for the array under study is

$$\begin{matrix}SNR = \frac{{( {i}_{sig} )}^{2}}{\overline{{i}_{noise}^{2}}} \\ = \frac{{( {10}^{- 10} )}^{2}}{( {10}^{- 22} )} \\ = 100\end{matrix} \qquad ( 17 )$$

The array NEP is larger than the pixel NEP by the square root of N since:

$$\begin{matrix}NEP = \frac{\sqrt{\overline{{i}_{noise}^{2}}}}{{R}_{i}} \\ = \frac{\sqrt{N \overline{{i}_{noise}^{2 ′}}}}{{R}_{i}^{′}} \\ = \sqrt{N} \cdot {NEP}^{′}\end{matrix} \qquad ( 18 )$$

This may seem confusing at first, but it should be kept in mind that the array gathers power from N pixels. The measured NEP for the array under study is 40 pW/√Hz and 10 pW/√Hz, for the lower and higher temperatures, respectively:

$$\begin{matrix}\begin{matrix}{NEP [ \frac{{A}^{2}}{Hz} ]}_{{lower}_{temp .}} = \frac{\sqrt{\overline{{i}_{noise}^{2}}}}{{R}_{i}} \\ = \frac{\sqrt{{10}^{- 22}}}{0.25} \\ = 40 pW\end{matrix} & ( 19 ) \\ \begin{matrix}{NEP [ \frac{{A}^{2}}{Hz} ]}_{{higher}_{temp .}} = \frac{\sqrt{\overline{{i}_{noise}^{2}}}}{{R}_{i}} \\ = \frac{\sqrt{{10}^{- 22}}}{1} \\ = 10 pW\end{matrix} & \end{matrix}$$

The value of NEP in Watt units depends on the bandwidth, which is determined by the readout circuitry as well as by the application. For sensing application we may assume that the sensor is activated every second and that the sensor is operated for 100 msec. Assuming a band pass filter with f₁=1Hz and f₂=10 Hz, the obtained value of the NEP in picowatt units is: NEP=40√ln(10/1)˜61 [pW].

The specific detectivity remains identical to that of a single pixel, since:

$$\begin{matrix}{D}^{*} = \frac{1}{NEP} \sqrt{A \cdot B} \\ = \frac{1}{\sqrt{N} \cdot {NEP}^{′}} \sqrt{{NA}^{′} \cdot B} \\ = {D}^{* ′}\end{matrix} \qquad ( 20 )$$

The measured detectivity D*_{λ} is:

D*_{λ}˜0.2·10¹⁰[cm·\sqrt{Hz}/Watt] (21)

The evaluated NETD improves over that of the single pixel since:

$$\begin{matrix}\begin{matrix}NETD = NEP \cdot ( 4 {f}_{\#}^{2} + 1 ) / ( A \cdot \frac{d {P}_{{λ}_{1} - {λ}_{2}}}{d T} ) \\ = \sqrt{N} \cdot {NEP}^{′} \cdot ( 4 {f}_{\#}^{2} + 1 ) / ( {NA}^{′} \cdot \frac{d {P}_{{λ}_{1} - {λ}_{2}}}{d T} )\end{matrix} & ( 22 ) \\ NETD = \frac{1}{\sqrt{N}} {NETD}^{′} & ( 23 )\end{matrix}$$

For the array under study, (dP/dT)|_{90-200 μm}˜6×10⁻⁶ [W/cm²/K], and the evaluated NETD is:

$$NETD = 61 \cdot {10}^{- 12} \frac{5}{1.6 \cdot {10}^{- 3} \cdot 1 \cdot {10}^{- 6}} \approx 0.2 K \qquad ( 24 )$$

The corresponding NETD of a single pixel, as confirmed by direct measurements of a single pixel, is larger by the square root of the number of pixels \sqrt{16}=4 yielding NETD=0.8K. From the measured data of FIG. 13, we readily obtain the temperature derivative D_{T} defined by D_{T}=δi_{sig}/δT_{BB}. The overall system capability to detect noise equivalent changes in the target temperature may be obtained directly from:

D_{T}=\sqrt{iₙ²}/ΔT. However, the direct derivation of ΔT assumes that \sqrt{iₙ²}=i_{sig}. The signal current depends on the optical transmission of the window as well as the filter attenuation. Hence, the derived ΔT characterizes the overall system and is not equal to the NETD, which is attributed to the sensor only (22).

### VII. Summary

A low cost measurement setup for THz applications, based on a blackbody source, which is a component-off-the shelf has been presented and characterized. This measurement approach resembles the natural operating conditions of passive imaging systems and hence it is more adequate for characterization of the operation of THz sensors and filters for uncooled passive systems than narrow band THz sources would be.

A blackbody at ˜1200° C. provides THz radiation on the order of ˜μW, but it is a broadband source. When the THz radiation is from a broadband source such as blackbody, radiation in other bands, such as NIR, LWIR and the visible, dominates the power. Hence, it is required to filter the other components in a suitable manner. It has been shown that as the blackbody temperature increases, the fraction of the useful THz radiation for calibration compared to the “unwanted” IR radiation, decreases. Hence, the THz filtering requirements become much more demanding, since a very high attenuation (>0.1%) of the unwanted IR radiation is required.

Commercial mesh filters [14] have been calibrated with two different sensors: one a commercial calibrated THz sensor [11] and the other a more sensitive IR sensor, dubbed TMOS [18]. In particular, the IR attenuation of the filters has been measured. It has been shown that the commercial THz sensor in practice responds to IR radiation and its calibration is valid only when using a well-defined, narrow band, THz source with practically no unwanted signals. In contrast, the TMOS directly measures the “leakage” of the unblocked IR radiation. The results indicate that the attenuation of the commercial filters is sufficient to block the unwanted IR radiation, provided that the blackbody temperatures are below ˜600K, since the measured attenuation is 5·10⁻³.

The calibration methodology of a small array of TeraMOS sensing pixels (4×4), which are electrically shortened but thermally isolated, in the blackbody setup, using the commercially available mesh filters, has been presented. The TeraMOS is implemented in standard CMOS-SOI and undergoes post processing by nano-machining to release a suspended transistor performing as an “active bolometer” [13].

The TeraMOS responsivity increases with the temperature because of its inherent non-linearity. This non-linearity is revealed in the blackbody measurement setup and when the sensor is exposed to hot targets such as the sun, as was observed in bolometers [19, 20]. This issue will need to be addressed by methods similar to those applied in imagers using bolometers, namely by having software applied for on-line calibration.

The reported values for the TeraMOS array are NEP˜61[pW] and NEP˜15[pW] for a single pixel with a bandwidth limited to 1-10 Hz. The evaluated NETD is of the order of 0.2K for the array and 0.8K for a single pixel. It was shown by Grossman et al. that the minimum NETD for an effective concealed object detection is ˜1K in unprocessed images [22]. Thus, the TeraMOS sensor reported here in standard 180 nm CMOS-SOI technology may enable monolithic uncooled passive THz imagers.

As proposed by the reviewers, the optical parts of the measurement setup may be significantly improved. Optical windows made either of High Density Poly Ethylene (HDPE) or High Resistivity Float Zone Silicon (HRFZ-Si) 5 mm thick, which are available commercially [23], may provide a much better optical window. The electrical part of the measurement system may be improved by using a closed-loop controlled chopper [24]. Improving the optical measurements and reducing the measurement electrical noise will enable measurements of the TeraMOS sensors at 500K or even at lower temperatures, as practiced for the more established uncooled passive IR sensors.

### REFERENCES

[1] Z. Popovic, E. N. Grossman, “THz Metrology and Instrumentation”, IEEE Transactions on Terahertz Science and Technology, vol. 1, no. 1, pp. 133-144, September 2011
[2] H.-W. Hubers, M. F. Kimmitt, N. Hiromoto, E. Brundermann, “Terahertz Spectroscopy: System and Sensitivity Considerations”, IEEE Transactions on Terahertz Science and Technology, vol. 1, no. 1, pp. 321-331, September 2011
[3] K. B. Cooper, R. J. Dengler, N. Llombart, B. Thomas, G. Chattopadhyay, P. H. Siegel, “THz Imaging Radar for Standoff Personnel Screening”, IEEE Transactions on Terahertz Science and Technology, vol. 1, no. 1, pp. 169-182, September 2011
[4] H. Hoshina, S. Ishii, S. Yamamoto, Y. Morisawa, H. Sato, T. Uchiyama, Y. Ozaki, C. Otani, “Terahertz Spectroscopy in Polymer Research: Assignment of Intermolecular Vibrational Modes and Structural Characterization of Poly(3-Hydroxybutyrate),” IEEE Transactions on Terahertz Science and Technology, vol. 3, no. 3
[5] B. St. Peter, S. Yngvesson, P. Siqueira, P. Kelly, A. Khan, S. Glick, A. Karellas, “Development and Testing of a Single Frequency Terahertz Imaging System for Breast Cancer Detection,” IEEE Transactions on Terahertz Science and Technology, vol. 3, no. 4, pp. 374-386, July 2013
[6] Y. C. Sim, K.-M. Ahn, J. Y. Park, C.-S. Park, J.-H. Son, “Temperature-Dependent Terahertz Imaging of Excised Oral Malignant Melanoma,” IEEE Transactions on Terahertz Science and Technology, vol. 3, no. 4, pp. 368-373, July 2013
[7] H. Sherry, J. Grzyb, Y. Zhao, R. Al Hadi, A. Cathelin, A. Kaiser and U. Pfeiffer, “A 1k Pixel CMOS Camera Chip for 25 fps Real-Time Terahertz Imaging Applications”, 2012 ISSCC, San Francisco, Calif., 19-23 Feb. 2012, pp. 252-253
[8] Y. Lee, Principles of Terahertz Science and Technology, Springer Science, Business Media, LLC, New York, 2009
[9] TeraTOP, Funded under the EU FP7 Programme, http://cordis.europa.eu/fp7/home_en.html
[10] G. Chattopadhyay, “Technology, Capabilities, and Performance of Low Power Terahertz Sources”, IEEE Transactions on Terahertz Science and Technology, vol. 1, no. 1, pp. 33-53, September 2011
[11] Ophir Photonics, http://www.ophiropt.com/
[12]A. Steiger, M. Kehrt, C C. Monte, and R. Müller, “Traceable terahertz power measurement from 1 THz to 5 THz”, Optics Express, Vol. 21(12), pp. 14466-14473 (2013)
[13] Y. Nemirovsky, A. Svetlitza, I. Brouk, S. Stolyarova, “Nanometric CMOS-SOI-NEMS transistor for uncooled THz sensing”, IEEE Transactions On Electron Devices, vol 60(5), pp. 1575-1583, 2013
[14] QMC Instruments, http://www.terahertz.co.uk/
[15]R. A. Wood, “Monolithic silicon microbolometer arrays,” in Semiconductors and Semimetals, vol. 47. New York: Academic, 1997, ch. 3, pp. 45-119.
[16] C. M. Hanson, “Hybrid pyroelectric-ferroelectric bolometer arrays” in Semiconductors and Semimetals, Vol. 47, edited by P. W. Kruse and D. D. Skatrud, San Diego, pp. 123-174, 1997
[17] E. Greenfield, “Ophir 3A-P THz meter”, The 2nd IIT THz Imaging Workshop, 2013
[18] L. Gitelman, S. Stolyarova, S. Bar-Lev, Z. Gutman, Y. Ochana, and Y. Nemirovsky, “CMOS-SOI-MEMS transistor for uncooled IR Imaging”, IEEE Trans. On Electron Devices, 56(9), pp. 1935-1942, 2009
[19] A. Fraenkel; U. Mizrahi; L. Bikov ; A. Adin ; E. Malkinson ; A. Giladi; D. Seter; Z. Kopolovich, “VOx-based uncooled micrbolometric detectors: recent developments at SCD”, Proc. SPIE 6206, Infrared Technology and Applications XXXII, 62061C (May 17, 2006)
[20] D. Dorn, O. Herrera, C. Tesdahl, E. Shumard, Y.-W. Wang, “Impacts and Mitigation Strategies of Sun Exposure on Uncooled Microbolometer Image Sensors”, SPIE8012-2011-149
[21] Nemirovsky, Y.; Corcos, D.; Brouk, I.; Nemirovsky, A.; Chaudhry, S., “1/f noise in advanced CMOS transistors,” IEEE Instrumentation & Measurement Magazine, vol. 14, no. 1, pp. 14-22, February 2011
[22] C. Dietlein, A. Luukanen, F. Meyer, Z. Popovic, and E. Grossman, “Phenomenology of Passive Terahertz Images”, Proc. 4th ESA Workshop on Millimetre-wave Technology and Applications, publ. VTT, Helsinki, pp. 405-410 (2006).
[23] http://www.tydex.ru
[24] http://www.thorlabs.de/newgrouppage9.cfm?objectgroup_id=287

### Teramos Performance Analysis for the Blackbody Setup

B.1 Responsivity and Non-Linear Effects

In the blackbody measurement setup, the directly measured parameter is the signal current as a function of the blackbody temperature T_{BB}, as shown in FIG. 13 (the red curve).

In the current readout mode, a bias voltage is applied. The TeraMOS steady state signal current is directly related to the change of the bias current as the pixel temperature increases:

$${i}_{sig} = {( \frac{d I}{d T} )}_{op . , {T}_{pixel}} \cdot Δ {T}_{pixel} .$$

The signal current depends on the TeraMOS operation point as well as its pixel temperature.

The absorbed blackbody radiation power Q with efficiency η induces a temperature increase, which may be calculated in the time domain, using the power equation:

$$I ( T ) V + η Q - {G}_{th} Δ T = {C}_{th} \frac{d Δ T}{d t} \qquad ( A1 )$$

The current change is due to the absorbed blackbody radiation power as well as the Joule self-heating imposed by the measurement (the term I(T)V). The I(T)V term cannot be ignored since it is larger than the absorbed THz radiation power. The signal current is defined as the change of I(T) that is directly related to optical radiation power.

Since the TeraMOS sensor is an “active bolometer”, similar to the TMOS IR sensor [18], we need to differentiate between large-signal and small-signal response, around a given operation point, at a given temperature.

When the incident power of FIG. 13 (the lower x axis) is expressed by (13) as

Q(T_{BB})=(A_{D}/4ƒ_{#}²)CFF··_{optics}·τ_{filter}·∫_{λ}_{₁}^{λ}^{₂}W_{λ}(T_{BB})dλ (A2)

the response may be regarded as large-signal since it is determined by the T_{BB} while for

$$Q ( {T}_{BB} ) = \frac{{A}_{D}}{4 {f}_{\#}^{2}} CFF \cdot {τ}_{optics} \cdot {{τ}_{filter} ( \frac{d {W}_{{λ}_{1} - {λ}_{2}}}{d T} )}_{T = {T}_{BB}} \cdot Δ {T}_{BB} \qquad ( A3 )$$

the response is regarded as small-signal since it is determined by incremental changes ΔT_{BB} around T_{BB}.

B.1.1 Small-Signal Analysis

The temperature change may be calculated in the time domain as well as in the frequency domain, where the Joule self-heating is taken into consideration by G_{th,eff} and τ_{eff}.

(A1) is non-linear, and in order to solve it a linear approximation is made:

I(T) [symbol] I₀(1+α·ΔT)

I₀=I(T₀) (A4)

The relevant figure of merit for the temperature sensing and the linearization is the Temperature Coefficient of Current (TCC), similar to the TCR of bolometers:

$$α ≡ TCC = \frac{1}{I} \frac{d I}{d T} \qquad ( A5 )$$

The above approximation (A1-A2) is based on the Taylor series where only the two first terms are accounted for. This is valid for sufficiently small temperature differences where α·←T=1 and hence higher order terms can be neglected. Under this approximation, (A1) can be rewritten as

$${I}_{0} V ( 1 + α \cdot Δ T ) + η Q - {G}_{th} Δ T = {C}_{th} \frac{d Δ T}{d t} \qquad ( A6 )$$

Or equivalently:

$${C}_{th} \frac{d Δ T}{d t} + {G}_{th} ( 1 - \frac{{I}_{0} α V}{{G}_{th}} ) Δ T = η Q + {I}_{0} V \qquad ( A7 )$$

The following constants are now defined:

$${G}_{th , eff} ≡ {G}_{th} [ 1 - \frac{{I}_{0} α V}{{G}_{th}} ] ; \\ {τ}_{th , eff} ≡ \frac{{C}_{th}}{{G}_{th , eff}} \qquad ( A8 )$$

When assuming steady state operation (d/dt=0), the temperature increase is

$$\begin{matrix}Δ T = \frac{η Q + {I}_{0} V}{{G}_{th} ( 1 - \frac{{I}_{0} α V}{{G}_{th}} )} \\ = \frac{η Q}{{G}_{th , eff}} + \frac{{I}_{0} V}{{G}_{th , eff}}\end{matrix} \qquad ( A9 )$$

The solution of (A7) in the frequency domain is obtained by using the Fourier transform:

$$Δ T ( t ) ↔ Δ \tilde{T} ( f ) = {\int }_{- ∞}^{+ ∞} Δ T ( t ) {e}^{- i2π ft} d t$$

$$Q ( t ) ↔ \tilde{Q} ( f ) = {\int }_{- ∞}^{+ ∞} Δ Q ( t ) {e}^{- i2π ft} d t$$

$$\frac{d }{d t} Δ T ( t ) ⇒ i 2 π f Δ \tilde{T} ( f )$$

The solution to the differential equation in the frequency domain can now be written as:

$$ΔT ( f ) = \frac{η Q ( f )}{{G}_{th , eff}} \frac{1}{\sqrt{1 + {[ 2 π {fC}_{th} / {G}_{th , eff} ]}^{2}}} + offset \qquad ( A10 )$$

In the measurement set-up described in section III, the incident blackbody radiation Q(f) is controlled by a chopper and the lock-in amplifier filters the measured signal around f and removes the offset.

The sensing pixel temperature increase ΔTₚᵢₓₑₗ, obtained from the power equation by small-signal linearization methods, is finally given by:

$$Δ {T}_{pixel} ( f ) = \frac{η Q ( f )}{{G}_{th , eff} \sqrt{1 + {( 2 π f {τ}_{eff} )}^{2}}} \qquad ( A11 )$$

where f is the chopper frequency and Q(f) is the incident optical power, modulated by the chopper. At low frequencies, expression (A21) is simplified to

$$Δ {T}_{pixel} = \frac{η Q ( {T}_{BB} )}{{G}_{th , eff}} .$$

The non-liner effects of the fundamental heat balance equation, associated with small-signal analysis, in particular due to self-heating, are “hidden” in G_{th,eff}.

The temperature responsivity, in units of K/Watt, of the TeraMOS, like all thermal sensors such as bolometers [see 15], is defined in DC by:

$${R}_{T} [ \frac{K}{Watt} ] = \frac{δ {T}_{pixel}}{δ Q} = \frac{1}{{G}_{th , eff}} \qquad ( A 12 )$$

B.1.2 Large-Signal Analysis

The TeraMOS signal current is expressed by:

$${i}_{sig} = {( \frac{d I}{d T} )}_{op . , {T}_{pixel}} \cdot Δ {T}_{pixel} = {( \frac{d I}{d T} )}_{op . , {T}_{pixel}} \cdot \frac{η Q ( {T}_{BB} )}{{G}_{th , eff}} \qquad ( A13 )$$

The pixel large-signal current responsivity is obtained from (A2) and is given by:

$${R}_{i} [ \frac{A}{Watt} ] = \frac{{i}_{sig}}{Q ( {T}_{BB} )} = \frac{η}{{G}_{th , eff}} \cdot {( \frac{d I}{d T} )}_{Tpixel , op .} \qquad ( A14 )$$

Because of the pixel electrical model, which includes two resistors in series with the TeraMOS, a more accurate definition of the large-signal current responsivity is:

$${R}_{i} = \frac{{i}_{out}}{Q} = \frac{η}{{G}_{th , eff}} \cdot ( \frac{d I}{d T} ) \cdot [ \frac{1}{1 + {g}_{m} ( {R}_{D} + {R}_{S} )} ] \qquad ( A15 )$$

The last term of (A15) is the pixel transfer function, modeled in [13]. The TeraMOS (large signal) current responsivity is also modeled in [13].

B.1.3 The Effect of Non-Linearity Upon Responsivity

The TeraMOS sensor, like all thermal sensors, is not linear and its responsivity increases with temperature, as reported in FIG. 13.

It should be noted that because of the electro-thermal effect and additional temperature dependent effects, even bolometers, which are passive resistors, are not linear any more, and hence G_{th,eff} is not constant. The simplified form of G_{th,eff} and the resulting

$${τ}_{eff} = \frac{{C}_{th}}{{G}_{th , eff}}$$

of

B1.1 are relevant only for temperatures around 300K-500K. When commercial bolometers are exposed to higher temperatures, either from the sun, hot targets or a blackbody heated to higher temperatures corresponding to those reported here, new effects known as “sun burnt”, “sun exposure” and other acronyms appear. The thermal time constant does not follow (A8) and it becomes large, introducing memory effects [19, 20].

The increase of the responsivity at higher blackbody temperature is also observed with the TMOS sensor, which may be regarded as “active bolometer” [18]. We have measured the responsivity of a TMOS sensor identical in dimensions and technology to the TeraMOS under study, using Ge optical window with deposited multilayer filter and applying blackbody temperatures between 500K-1400K. In this case, the TMOS optical package accurately defines the optical band pass and there is no ambiguity regarding the nature of the radiation since the sensor measures only the blackbody IR radiation. Still, the measured responsivity monotonically increases with the blackbody temperature by a factor of 5-10.

To conclude this section, it is not surprising that thermal sensors are characterized by “Blackbody Radiation Detectivity”—D*_{BB}(T, f) in contrast to the “spectral monochromatic Detectivity” D*_{λ}(λ, ƒ) of quantum sensors. In such cases one needs to specify the blackbody temperature when reporting detectivity or responsivity. For example, commercial pyroelectric sensors are characterized at T=500K, as can be seen in data sheets.

B.2 The Temperature Derivative

In the measurement setup defined above, the temperature derivative of the TeraMOS is defined by:

$${D}_{T} ≡ \frac{δ {i}_{sig}}{δ {T}_{BB}} \qquad ( A16 )$$

It expresses the variation of the measured signal current due to a change in the temperature of the blackbody. Below we relate this expression to the well-established thermal responsivity and current responsivity of thermal sensors.

The measured data shown in FIG. 13 yield the temperature derivative of the TeraMOS

$${D}_{T} ≡ \frac{δ {i}_{sig}}{δ {T}_{BB}} = ( \frac{δ {i}_{sig}}{δ Q} ) ( \frac{δ Q}{δ T} ) ( \frac{δ T}{δ {T}_{BB}} ) = {R}_{i}^{′} \frac{1}{{R}_{T}} ( \frac{δ T}{δ {T}_{BB}} ) \\ where {R}_{i}^{′} = {( \frac{δ {i}_{sig}}{δ Q} )}_{op , {T}_{pixel }} \qquad ( A17 )$$

is the small-signal responsivity around a given operation point and pixel temperature;

$${R}_{T} = ( \frac{δ T}{δ Q} )$$

is the temperature responsivity. Accordingly, (A17) can be re-written as:

$${D}_{T} = {R}_{i}^{′} ( {G}_{th , eff} ) ( \frac{δ T}{δ {T}_{BB}} ) \qquad ( A18 )$$

The transfer function of the temperature ratio between the blackbody and the pixel,

$$( \frac{δ T}{δ {T}_{BB}} ) ,$$

assuming small signal, is obtained from

$${( Δ T )}_{pixel} = \frac{η Q ( {T}_{BB} )}{{G}_{th , eff}} ,$$

while Q(T_{BB}) is given by (A3). Accordingly,

$$\frac{{( Δ T )}_{pixel}}{{( Δ T )}_{BB}} = \frac{η}{{G}_{th , eff}} \cdot \frac{{A}_{D}}{4 {f}_{\#}^{2}} \cdot CFF \cdot {τ}_{optics} \cdot {{τ}_{filter} ( \frac{d {W}_{{λ}_{1} - {λ}_{2}}}{d T} )}_{T = {T}_{BB}} \qquad ( A19 )$$

Below we relate the measured D_{T} and the “small signal” current responsivity R′ᵢ:

$${D}_{T} ≡ \frac{δ {i}_{sig}}{δ {T}_{BB}} = {R}_{i}^{′} \cdot ( {A}_{D} / 4 {f}_{\#}^{2} ) CFF \cdot {τ}_{optics} \cdot {{τ}_{filter} ( \frac{d {W}_{{λ}_{1} - {λ}_{2}}}{d T} )}_{T = {T}_{BB}} \qquad ( A20 )$$

It is readily seen that D_{T} as defined for the TeraMOS in the blackbody setup is obtained by multiplying the “small signal” current responsivity R′ᵢ with the temperature derivative of the integrated Planck's radiation law between the two wavelengths of interest, multiplied by several system parameters. The latter include the optics f-number (ƒ_{#}) the transmission of the optics and the filter, the sensor area A_{D} as well as the Chopping Forming Factor (CH). Hence, the temperature derivative characterizes the whole measurement setup and not just the sensor.

We claim:

1. A TeraHertz radiating system, comprising:
a blackbody arranged to emit blackbody radiation that comprises a TeraHertz component, a visible light component and an infrared component; and
a filtering module that is arranged to pass the TeraHertz component and to reject the visible light component and the infrared component to provide filtered radiation.

2. The TeraHertz radiating system according to claim 1, wherein the filtering module comprises at least one mesh filter.

3. The TeraHertz radiating system according to claim 1, wherein the filtering module comprises scattering sheet filters.

4. The TeraHertz radiating system according to claim 1, wherein the filtering module comprises a cascade of mesh filters and scattering sheet filters.

5. The TeraHertz radiating system according to claim 1, wherein a peak of radiation intensity of the blackbody radiation is within a TeraHertz region.

6. The TeraHertz radiating system according to claim 1, wherein the blackbody is arranged to be heated to about 1200 Celsius when emitting the blackbody radiation.

7. The TeraHertz radiating system according to claim 1, further comprising optics for directing the filtered radiation to a location of interest.

8. The TeraHertz radiating system according to claim 1, further comprising a sensor adaptor arranged to (a) support a sensor, and to (b) receive detection signals generated from the sensor in response to the filtered radiation.

9. The TeraHertz radiating system according to claim 1, further comprising a sensor.

10. The TeraHertz radiating system according to claim 9 further comprising a modulator that is arranged to prevent, during first periods of time, the sensor from receiving the filtered radiation and to pass, during second periods of time, the filtered radiation.

11. The TeraHertz radiating system according to claim 10, wherein the processor is arranged to process the detection signals received during the first and second periods of time.

12. The TeraHertz radiating system according to claim 9, further comprising a processor for processing the detection signals and to provide information about sensing parameters of the sensor.

13. A method for generating and utilizing TeraHertz radiation, the method comprises:
emitting, by a blackbody, blackbody radiation that comprises a TeraHertz component, a visible light component and an infrared component; and
filtering by a filtering module the blackbody radiation to provide filtered radiation thereby passing the TeraHertz component and rejecting the visible light component and the infrared component.

14. The method according to claim 13, wherein the filtering module comprises at least one mesh filter.

15. The method according to claim 13, wherein the filtering module comprises scattering sheet filters.

16. The method according to claim 13, wherein the filtering module comprises a cascade of mesh filters and scattering sheet filters.

17. The method according to claim 13, wherein a peak of radiation intensity of the blackbody radiation is within a TeraHertz region.

18. The method according to claim 13, comprising heating the blackbody to about 1200 Celsius when emitting the blackbody radiation.

19. The method according to claim 13, further comprising directing, by optics, the filtered radiation to a location of interest.

20. The method according to claim 19, further comprising supporting, by a sensor adaptor, a sensor, and receiving detection signals generated from the sensor in response to the filtered radiation.

21. The method according to claim 13, further comprising generating by a sensor detection signals in response to the filtered radiation.

22. The method according to claim 21, comprising processing, by a processor, the detection signals to provide information about sensing parameters of the sensor.

23. The method according to claim 21 comprising preventing by a modulator, during first periods of time, the sensor from receiving the filtered radiation and passing, during second periods of time, the filtered radiation.

24. The method according to claim 23, comprising processing, by a processor, detection signals received during the first and second periods of time.
